(19) United States
(12) Patent Application Publication
(10) Pub. No.: US 2021/0002397 A1
(43) Pub. Date: Jan. 7, 2021

(54) PROCESS FOR PREPARING PROPYLENE COPOLYMERS COMPRISING C4-C12-APHA OLEFIN COMONOMER UNITS

(71) Applicant: BOREALIS AG, Vienna (AT)

(72) Inventors: Matthias Hoff, Linz (AT); Luigi Resconi, Linz (AT); Simon Schwarzenberger, Linz (AT); Wilfried Töltsch, Linz (AT)

(21) Appl. No.: 16/979,379

(22) PCT Filed: May 7, 2019
(86) PCT No.: PCT/EP2019/061635

§ 371 Date: Sep. 9, 2020

(30) Foreign Application Priority Data
May 9, 2018 (EP) 18171551.7

(51) Int. Cl. C08F 210/06; C08F 210/08; C08F 210/14; C08F 210/02; C08F 2/00; C08F 2/34; C08F 4/659; C08F 4/6592

(52) U.S. Cl. CPC C08F 210/06; C08F 210/08; C08F 210/14; C08F 210/02; C08F 4/65927; C08F 2/34; C08F 4/65908; C08F 4/65912; C08F 2/001

(57) ABSTRACT

The present invention relates to a process for producing a copolymer of propylene, optionally ethylene, and at least one comonomer selected from alpha olefins having from 4 to 12 carbon atoms using a specific class of metallocene complexes in combination with a cocatalyst system comprising a boron containing cocatalyst and an aluminoxane cocatalyst, preferably in a multistage polymerization process including a gas phase polymerization step.

The present invention relates to a process for producing a propylene copolymer comprising C₄-C₁₂-alpha olefin comonomer units using a specific class of metallocene complexes in combination with a cocatalyst system comprising a boron containing cocatalyst and an aluminoxane cocatalyst.

The invention further relates to the use of catalysts which comprise a specific class of metallocene complexes in combination with a cocatalyst system comprising a boron containing cocatalyst and an aluminoxane cocatalyst to produce a propylene copolymer comprising C₄-C₁₂-alpha olefin comonomer units.

### BACKGROUND OF THE INVENTION

Metallocene catalysts have been used to manufacture polyolefins for many years. Countless academic and patent publications describe the use of these catalysts in olefin polymerization. Metallocenes are now used industrially and polyethylenes and polypropylenes in particular are often produced using cyclopentadienyl based catalyst systems.

Metallocene catalysts are used in propylene polymerization in order to achieve some desired polymer properties.

However, there are some problems in using metallocene catalysts on industrial scale especially in multistage polymerization configurations.

Thus, there is room for improving the process and catalyst behaviour in the process. Metallocene catalysts for polypropylene generally show a very steep molecular weight capability response to hydrogen, that is, the melt flow rate of metallocene catalysed polypropylene strongly increases by even a mild increase in hydrogen concentration in the polymerization medium. On the other hand, the use of hydrogen is needed to reach acceptable catalyst productivities.

For this reason, in industrial scale metallocene catalysts are mostly used for the production of high flow polypropylene materials.

In addition, in the case of copolymerization of propylene and higher alpha-olefins (such as butene and hexene) with metallocene-based catalysts, the higher alpha-olefin tends to lower both catalyst activity and copolymer molecular weight.

The advantage of using metallocene catalysts for such copolymers is that they have far better butene and hexene incorporation than Ziegler-Natta catalysts. However, for use of propylene-butene and propylene-hexene copolymers in applications such as blown film, BOPP and pipes, high molecular weights (low MFR) are required, without sacrificing catalyst productivity and other properties, thus metallocene catalysts have limited applicability for these uses due to the aforementioned too strong response to hydrogen and the adverse effect of comonomer on activity and molecular weight.

The problem was partially solved by using catalysts based on metallocenes as disclosed in WO 2015/014632. Still, catalyst activity was decreased when increasing the hexene content, and still hexene increased the melt flow rate of the copolymer.

Thus it is desired to find metallocene catalyst systems, which have improved performance in the production of propylene copolymers comprising C₄-C₁₂-alpha olefin comonomer units, for instance having high activity for high Mw propylene copolymer comprising C₄-C₁₂-alpha olefin comonomer units products. The desired catalysts should also have improved performance in the production of high molecular weight propylene copolymers comprising C₄-C₁₂-alpha olefin comonomer units, whereby the propylene copolymer comprising C₄-C₁₂-alpha olefin comonomer units should have higher melting points compared to propylene copolymers comprising C₄-C₁₂-alpha olefin comonomer units produced with metallocene catalyst systems of the prior art.

Although a lot of work has been done in the field of metallocene catalysts, there still remain some problems, which relate mainly to the productivity or activity of the catalysts, in particular in multistage polymerization processes, since the productivity or activity has been found to be relatively low, especially when polymers of low melt index (MI) (i.e. high molecular weight, Mw) are produced.

The inventors have identified a catalyst system composed of a specific class of metallocene catalysts in combination with a cocatalyst system comprising a boron containing cocatalyst and an aluminoxane cocatalyst having improved polymerization behaviour, higher catalyst productivity, improved performance in the production of high molecular weight propylene/C₄-C₁₂-alpha olefin copolymers with higher melting points compared to systems known in the art, enabling the production of propylene/C₄-C₁₂-alpha olefin copolymers at high Mw, thus being ideal for the production of high molecular weight propylene/C₄-C₁₂-alpha olefin copolymers. The specific catalyst system gives a higher flexibility/freedom in the design of propylene polymers than prior art catalyst systems.

### SUMMARY OF THE INVENTION

The present invention provides a process for polymerizing a copolymer of propylene and at least one comonomer selected from alpha olefins having from 4 to 12 carbon atoms, and optionally ethylene, in the presence of a single-site catalyst comprising
(i) a complex of formula (I)

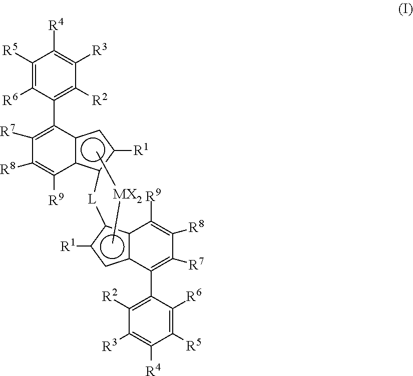

wherein
M is zirconium or hafnium;
each X independently is a sigma-donor ligand
L is a bridge of formula -(ER¹⁰₂)_{y}—;
y is 1 or 2;
E is C or Si;
each R¹⁰ is independently a C₁-C₂₀-hydrocarbyl group, tri(C₁-C₂₀ alkyl)silyl group, C₆-C₂₀ aryl group, C₇-C₂₀ arylalkyl group or C₇-C₂₀ alkylaryl group or L is an alkylene group such as methylene or ethylene;
R¹ are each independently the same or are different from each other and are a CH₂—R¹¹ group, with R¹¹ being H or linear or branched C₁-C₆ alkyl group, C₃-C₈ cycloalkyl group, C₆-C₁₀ aryl group;
R³, R⁴ and R⁵ are each independently the same or different from each other and are H or a linear or branched C₁-C₆ alkyl group, C₇-C₂₀ arylalkyl group, C₇-C₂₀ alkylaryl group, or C₆-C₂₀ aryl group with the proviso that if there are four or more R³, R⁴ and R⁵ groups different from H present in total, one or more of R³, R⁴ and R⁵ is other than tert butyl;
R⁷ and R⁸ are each independently the same or different from each other and are H, a CH₂—R¹² group, with R¹² being H or linear or branched C₁-C₆ alkyl group, SiR¹³₃, GeR¹³₃, OR¹³, SR¹³, NR¹³₂,
wherein
R¹³ is a linear or branched C₁-C₆ alkyl group, C₇-C₂₀ alkylaryl group and C₇-C₂₀ arylalkyl group or C₆-C₂₀ aryl group,
and/or
R⁷ and R⁸ are part of a C₄-C₂₀ carbon ring system together with the indenyl carbons to which they are attached, preferably a C₅ ring, optionally one carbon atom can be substituted by a nitrogen, sulfur or oxygen atom; and
R², R⁶ and R⁹ all are H; and
(ii) a cocatalyst system comprising a boron containing cocatalyst and an aluminoxane cocatalyst;

and in the presence of hydrogen.

The catalyst of the invention can be used in non-supported form or in solid form.

The catalyst of the invention may be used as a homogeneous catalyst or heterogeneous catalyst.

The catalyst of the invention in solid form, preferably in solid particulate form can be either supported on an external carrier material, like silica or alumina, or, in a particularly preferred embodiment, is free from an external carrier, however still being in solid form. For example, the solid catalyst is obtainable by a process in which
(A) a liquid/liquid emulsion system is formed, said liquid/liquid emulsion system comprising a solution of the catalyst components (i) and (ii) dispersed in a solvent so as to form dispersed droplets; and
(B) solid particles are formed by solidifying said dispersed droplets.

In another aspect the present invention relates to a copolymer of propylene and at least one comonomer selected from alpha olefins having from 4 to 12 carbon atoms or a terpolymer of propylene, ethylene and at least one comonomer selected from alpha olefins having from 4 to 12 carbon atoms obtainable from the process according to the invention as defined above or below, wherein the copolymer of propylene and at least one comonomer selected from alpha olefins having from 4 to 12 carbon atoms or terpolymer of propylene, ethylene and at least one comonomer selected from alpha olefins having from 4 to 12 carbon atoms follows the following relation (A) in behalf of its polymerization process:

MFR₂/[H₂/C₃]≤55 [g/10 min/mol/kmol] (A)

with
MFR₂ melt flow rate in g/10 min of the copolymer of propylene and at least one comonomer selected from alpha olefins having from 4 to 12 carbon atoms or terpolymer of propylene, ethylene and at least one comonomer selected from alpha olefins having from 4 to 12 carbon atoms, determined according to ISO 1133 at a temperature of 230° C. and a load of 2.16 kg;

[H₂/C₃] molar ratio of hydrogen to propylene in mol/kmol in process step b);

wherein the molar ratio of hydrogen to propylene, [H₂/C₃], in process step b) is at least 0.18 mol/kmol.

Finally, the present invention also relates to the use of a single-site catalyst comprising
(i) a complex of formula (I)

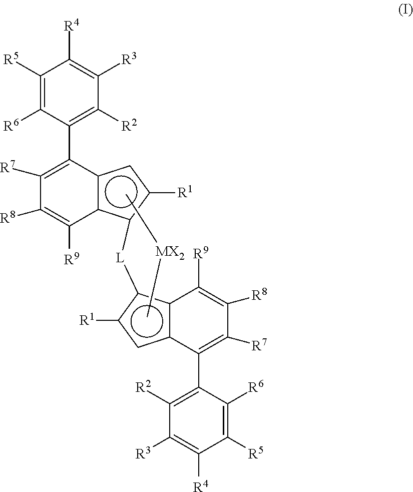

wherein
M is zirconium or hafnium;
each X independently is a sigma-donor ligand
L is a bridge of formula -(ER¹⁰₂)_{y}—;
y is 1 or 2;
E is C or Si;
each R¹⁰ is independently a C₁-C₂₀-hydrocarbyl group, tri(C₁-C₂₀ alkyl)silyl group, C₆-C₂₀ aryl group, C₇-C₂₀ arylalkyl group or C₇-C₂₀ alkylaryl group or L is an alkylene group such as methylene or ethylene;
R¹ are each independently the same or are different from each other and are a CH₂—R¹¹ group, with R¹¹ being H or linear or branched C₁-C₆ alkyl group, C₃-C₈ cycloalkyl group, C₆-C₁₀ aryl group;
R³, R⁴ and R⁵ are each independently the same or different from each other and are H or a linear or branched C₁-C₆ alkyl group, C₇-C₂₀ arylalkyl group, C₇-C₂₀ alkylaryl group, or C₆-C₂₀ aryl group with the proviso that if there are four or more R³, R⁴ and R⁵ groups different from H present in total, one or more of R³, R⁴ and R⁵ is other than tert butyl;
R⁷ and R⁸ are each independently the same or different from each other and are H, a CH₂—R¹² group, with R¹² being H or linear or branched C₁-C₆ alkyl group, SiR¹³₃, GeR¹³₃, OR¹³, SR¹³, NR¹³₂,
wherein
R¹³ is a linear or branched C₁-C₆ alkyl group, C₇-C₂₀ alkylaryl group and C₇-C₂₀ arylalkyl group or C₆-C₂₀ aryl group,
and/or
R⁷ and R⁸ are part of a C₄-C₂₀ carbon ring system together with the indenyl carbons to which they are attached, preferably a C₅ ring, optionally one carbon atom can be substituted by a nitrogen, sulfur or oxygen atom;
R⁹ are each independently the same or different from each other and are H or a linear or branched C₁-C₆ alkyl group; and
R² and R⁶ all are H; and
(ii) a cocatalyst system comprising a boron containing cocatalyst and an aluminoxane cocatalyst

for the production of a copolymer of propylene and at least one comonomer selected from alpha olefins having from 4 to 12 carbon atoms or a terpolymer of propylene, ethylene and at least one comonomer selected from alpha olefins having from 4 to 12 carbon atoms as defined above or below.

### DETAILED DESCRIPTION OF THE INVENTION

The complexes and hence catalysts of the invention are based on formula (I) as hereinbefore defined. The complexes of the invention are asymmetrical. Asymmetrical means simply that the two indenyl ligands forming the metallocene are different, that is, each indenyl ligand bears a set of substituents that are either chemically different, or located in different positions with respect to the other indenyl ligand. Symmetrical complexes are based on two identical indenyl ligands.

In one embodiment the complexes used according to the invention are symmetrical.

In another embodiment the complexes used according to the invention are asymmetrical.

In the catalysts of the invention the following preferences apply:

M is zirconium or hafnium, preferably zirconium.

The complexes of the invention are preferably chiral, racemic bridged bisindenyl C₁-symmetric metallocenes. Although the complexes of the invention are formally C₁-symmetric, the complexes ideally retain a pseudo-C₂-symmetry since they maintain C₂-symmetry in close proximity of the metal center although not at the ligand periphery. By nature of their chemistry both anti and syn enantiomer pairs (in case of C₁-symmetric complexes) are formed during the synthesis of the complexes. For the purpose of this invention, racemic or racemic-anti means that the two indenyl ligands are oriented in opposite directions with respect to the cyclopentadienyl-metal-cyclopentadienyl plane, while meso or racemic-syn means that the two indenyl ligands are oriented in the same direction with respect to the cyclopentadienyl-metal-cyclopentadienyl plane, as shown in the Figure below.

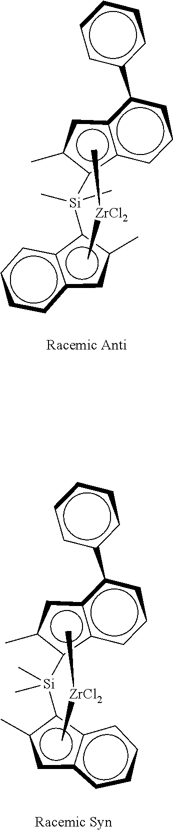

Formula (I), and any sub formulae, are intended to cover both syn- and anti-configurations. Preferred complexes are in the anti configuration.

It is preferred, if the metallocenes of the invention are employed as the racemic or racemic-anti isomers, ideally therefore at least 95.0 mol %, such as at least 98.0 mol %, especially at least 99.0 mol % of the metallocene is in the racemic or racemic-anti isomeric form.

In the definitions below the term hydrocarbyl group includes alkyl groups, alkenyl groups, alkynyl groups, cycloalkyl groups, cycloalkenyl groups, aryl groups, alkylaryl groups or arylalkyl groups or of course mixtures of these groups such as cycloalkyl substituted by alkyl.

In the catalysts of the invention the following preferences apply:

M is zirconium or hafnium, preferably zirconium.

Each X independently is a sigma-donor ligand.

Thus each X independently may be the same or different, and is preferably a hydrogen atom, a halogen atom, a linear or branched, cyclic or acyclic C₁-C₂₀-alkyl or -alkoxy group, a C₆-C₂₀-aryl group, a C₇-C₂₀-alkylaryl group or a C₇-C₂₀-arylalkyl group; optionally containing optionally containing one or more heteroatoms of Group 14-16 of the periodic table.

The term halogen includes fluoro, chloro, bromo and iodo groups, preferably chloro groups.

The term heteroatoms belonging to groups 14-16 of the periodic table includes for example Si, N, O or S.

More preferably each X is independently a hydrogen atom, a halogen atom, a linear or branched C₁-C₆-alkyl or C₁-C₆-alkoxy group, a phenyl or benzyl group.

Yet more preferably each X is independently a halogen atom, a linear or branched C₁-C₄-alkyl or C₁-C₄-alkoxy group, a phenyl or benzyl group.

Most preferably each X is independently chlorine, benzyl or a methyl group.

Preferably both X groups are the same.

The most preferred options for both X groups are two chlorides, two methyl or two benzyl groups.

L is a bridge of formula -(ER¹⁰₂)_{y}—, with y being 1 or 2, E being C or Si, and each R¹⁰ is independently a C₁-C₂₀-hydrocarbyl or tri(C₁-C₂₀-alkyl)silyl, or L is an alkylene group such as methylene or ethylene.

The bridge L thus can be an alkylene linker such as a methylene or ethylene linker or -(ER¹⁰₂)_{y}— can be a bridge of the formula —SiR¹⁰₂—, wherein each R¹⁰ is independently a C₁-C₂₀-hydrocarbyl or tri(C₁-C₂₀-alkyl)silyl.

The term C₁-C₂₀-hydrocarbyl group includes C₁-C₂₀-alkyl, C₂-C₂₀-alkenyl, C₂-C₂₀-alkynyl, C₃-C₂₀-cycloalkyl, C₃-C₂₀-cyclo alkenyl, C₆-C₂₀-aryl groups, C₇-C₂₀-alkylaryl groups or C₇-C₂₀-arylalkyl groups or of course mixtures of these groups such as cycloalkyl substituted by alkyl. Unless otherwise stated, preferred C₁-C₂₀-hydrocarbyl groups are C₁-C₂₀-alkyl, C₄-C₂₀-cyclo alkyl, C₅-C₂₀-cycloalkyl-alkyl groups, C₇-C₂₀-alkylaryl groups, C₇-C₂₀-arylalkyl groups or C₆-C₂₀-aryl groups. If L is an alkylene linker group, ethylene and methylene are preferred.

It is preferred that R¹⁰ is independently a C₁-C₁₀-hydrocarbyl, such as methyl, ethyl, propyl, isopropyl, tert.-butyl, isobutyl, C₅-C₆-cycloalkyl, cyclohexylmethyl, phenyl or benzyl, more preferably both R¹⁰ are a C₁-C₆-alkyl, C₃-C₈-cycloalkyl or C₆-aryl group, such as a C₁-C₄-alkyl, C₅-C₆-cycloalkyl or C₆-aryl group and most preferably both R¹⁰ are methyl or one is methyl and another cyclohexyl. Preferably both R¹⁰ groups are the same.

Alkylene linkers are preferably methylene or ethylene.

L is most preferably —Si(CH₃)₂—.

R¹ are each independently the same or can be different and are a CH₂—R¹¹ group, with R¹¹ being H or linear or branched C₁-C₆-alkyl group, like methyl, ethyl, n-propyl, i-propyl, n-butyl, i-butyl, sec.-butyl and tert.-butyl or C₃-C₈ cycloalkyl group (e.g. cyclohexyl), C₆-C₁₀ aryl group (e.g. phenyl).

Preferably R¹ are the same and are a CH₂—R¹¹ group, with R¹¹ being H or a linear or branched C₁-C₄-alkyl group, more preferably R¹ are the same and are a CH₂—R¹¹ group, with R¹¹ being H or a linear or branched C₁-C₃-alkyl group. Most preferably R¹ are both methyl.

R³, R⁴ and R⁵ are each independently the same or different from each other and are H or a linear or branched C₁-C₆ alkyl group, C₇-C₂₀ arylalkyl group, C₇-C₂₀ alkylaryl group, or C₆-C₂₀ aryl group with the proviso that if there are four or more R³, R⁴ and R⁵ groups different from H present in total, one or more of R³, R⁴ and R⁵ is other than tert butyl.

Preferably R³, R⁴ and R⁵ are each independently the same or different from each other and are H or a linear or branched C₁-C₆ alkyl group, C₇-C₂₀ arylalkyl group, C₇-C₂₀ alkylaryl group, or C₆-C₂₀ aryl group, whereby at least one of R³, R⁴ and R⁵ is different from H with the proviso that if there are four or more R³, R⁴ and R⁵ groups different from H present in total, one or more of R³, R⁴ and R⁵ is other than tert butyl.

More preferably R³, R⁴ and R⁵ are each independently the same or can be different and are hydrogen, a linear or branched C₁-C₆-alkyl group or C₆-C₂₀ aryl groups, more preferably a linear or branched C₁-C₄_alkyl group, whereby at least one of R³, R⁴ and R⁵ is different from hydrogen.

Most preferably each R³, R⁴ and R⁵ are independently hydrogen, methyl, ethyl, isopropyl or tert.-butyl, especially methyl or tert.-butyl, whereby at least one of R³, R⁴ and R⁵ is different from hydrogen.

The total number of the R³, R⁴ and R⁵ substituents different from hydrogen is ideally 2, 3 or 4.

In one embodiment the phenyl ring(s) is/are substituted with one substituent. In this embodiment the substituent is preferably situated in para position. This means R³ and R⁵ are H and R⁴ is a linear or branched C₁-C₆-alkyl group or C₆-C₂₀ aryl groups, more preferably a linear or branched C₁-C₄_alkyl group.

In another embodiment the phenyl ring(s) is/are substituted with two substituent. In this embodiment the substituent is preferably situated in meta position. This means R⁴ is H and R³ and R⁵ are a linear or branched C₁-C₆-alkyl group or C₆-C₂₀ aryl groups, more preferably a linear or branched C₁-C₄ alkyl group.

In all embodiments of the invention the substitution of the phenyl groups are subject to the proviso that the complex is substituted in total with 0, 1, 2 or 3 tert.-butyl groups across the two phenyl rings combined, preferably 0, 1 or 2 tert.-butyl groups across the two phenyl rings combined.

Alternatively stated, if the number of substituents sum to 4 or more, at least one R³, R⁴ and R⁵ group present cannot represent tert butyl.

Ideally, no phenyl ring will comprise two branched substituents. If a phenyl ring contains two substituents, then it is preferred if two of R³, R⁴ and R⁵ are C₁-C₄ linear alkyl, e.g. methyl.

If a phenyl ring contains one substituent, then it is preferred that one of R³, R⁴ and R⁵ is a branched C₄-C₆ alkyl, e.g. tert butyl.

R⁷ and R⁸ are each independently the same or different from each other and are H, a CH₂—R¹² group, with R¹² being H or linear or branched C₁-C₆ alkyl group, SiR¹³₃, GeR¹³₃, OR¹³, SR¹³, NR¹³₂, wherein R¹³ is a linear or branched C₁-C₆ alkyl group, C₇-C₂₀ alkylaryl group and C₇-C₂₀ arylalkyl group or C₆-C₂₀ aryl group, and/or

R⁷ and R⁸ are part of a C₄-C₂₀ carbon ring system together with the indenyl carbons to which they are attached, preferably a C₅ ring, optionally one carbon atom can be substituted by a nitrogen, sulfur or oxygen atom.

In one embodiment R⁸ preferably is the same same or different from each other and is H, a CH₂—R¹² group, with R¹² being H or linear or branched C₁-C₆ alkyl group, whereby each R¹² independently can be the same or different, and

R⁷ is each independently the same or different from each other and is SiR¹³₃, GeR¹³₃, OR¹³, SR¹³, NR¹³₂, wherein R¹³ is a linear or branched C₁-C₆ alkyl group, C₇-C₂₀ alkylaryl group and C₇-C₂₀ arylalkyl group or C₆-C₂₀ aryl group.

R¹² is preferably a linear or branched C₁-C₄-alkyl group, more preferably with R¹² being the same and being a C₁-C₂-alkyl group. Most preferably R⁸ is a tert.-butyl group and hence all R¹² groups are methyl.

Preferably R⁷ is OR¹³, wherein R¹³ is a linear or branched C₁-C₆ alkyl group such as methyl, ethyl, n-propyl, i-propyl, n-butyl, i-butyl, sec.-butyl and tert.-butyl, preferably a linear C₁-C₄-alkyl group, more preferably a C₁-C₂-alkyl group and most preferably methyl.

In another embodiment R⁷ and R⁸ are part of a C₄-C₂₀ carbon ring system together with the indenyl carbons to which they are attached, preferably a C₅ ring, optionally one carbon atom can be substituted by a nitrogen, sulfur or oxygen atom.

R⁹ are each independently the same or different from each other and are H or a linear or branched C₁-C₆ alkyl group, most preferably all R⁹ are H.

It is preferred that at least one of the substituents R³, R⁴, R⁵, R⁷, R⁸ and R⁹ is different from H.

In one preferred embodiment,

M is zirconium or hathium; preferably zirconium;

each X independently is independently a hydrogen atom, a halogen atom, a linear or branched C₁-C₆-alkyl or C₁-C₆-alkoxy group, a phenyl or benzyl group, more preferably both X groups are two chlorides, two methyl or two benzyl groups, and most preferably both X groups are two chlorides;

L is a bridge of the formula —SiR¹⁰₂—, wherein each R¹⁰ is independently a C₁-C₂₀-hydrocarbyl or tri(C₁-C₂₀-alkyl)silyl; more preferably both R¹⁰ are a C₁-C₆-alkyl, C₃-C₈-cycloalkyl or C₆-aryl group, such as a C₁-C₄-alkyl, C₅-C₆-cycloalkyl or C₆-aryl group.

L is most preferably —Si(CH₃)₂—;

R¹ are each independently the same or are different from each other and are a CH₂—R¹¹ group, with R¹¹ being H or linear or branched C₁-C₆ alkyl group, preferably R¹ are the same and are a CH₂—R¹¹ group, with R¹¹ being H or a linear or branched C₁-C₄-alkyl group, most preferably R′ are both methyl;

R³, R⁴ and R⁵ are each independently the same or different from each other and are H or a linear or branched C₁-C₆ alkyl group, with the proviso that if there are four or more R³, R⁴ and R⁵ groups different from H present in total, one or more of R³, R⁴ and R⁵ is other than tert.-butyl, preferably each R³, R⁴ and R⁵ are independently hydrogen, methyl, ethyl, isopropyl or tert.-butyl, especially methyl or tert.-butyl, whereby at least one of R³, R⁴ and R⁵ is different from hydrogen

R⁸ preferably is the same same or different from each other and is H, a CH₂—R¹² group, with R¹² being H or linear or branched C₁-C₆ alkyl group, most preferably R⁸ preferably is H or tert.-butyl;

R⁷ is the same same or different from each other and is H or OR¹³, wherein R¹³ is a linear or branched C₁-C₆ alkyl group such as methyl, ethyl, n-propyl, i-propyl, n-butyl, i-butyl, sec.-butyl and tert.-butyl, preferably a linear C₁-C₄-alkyl group, more preferably a C₁-C₂-alkyl group and most preferably methyl; and

R², R⁶ and R⁹ all are H.

Particular preferred complexes of said embodiment include:
rac-anti-dimethylsilandiyl(2-methyl-4-phenyl-5-methoxy-6-tert-butyl-indenyl)(2-methyl-4-(4-tert-butylphenyl)indenyl)zirconium dichloride,
rac-anti-dimethylsilandiyl(2-methyl-(4-tert-butyl-phenyl)-5-methoxy-6-tert-butyl-indenyl)(2-methyl-4-(4-tert-butylphenyl)indenyl)zirconium dichloride,
rac-dimethylsilandiyl-di(2-methyl-4-(3,5-dimethylphenyl)-5-methoxy-6-tert-butyl-indenyl)zirconium dichloride and
rac-dimethylsilandiyl-di(2-methyl-4-(4-tert-butyl-phenyl)-5-methoxy-6-tert-butyl-indenyl)zirconium dichloride.

In another preferred embodiment,

M is zirconium or hathium; preferably zirconium;

each X independently is independently a hydrogen atom, a halogen atom, a linear or branched C₁-C₆-alkyl or C₁-C₆-alkoxy group, a phenyl or benzyl group, more preferably both X groups are two chlorides, two methyl or two benzyl groups, and most preferably both X groups are two chlorides;

L is a bridge of the formula —SiR¹⁰₂—, wherein each R¹⁰ is independently a C₁-C₂₀-hydrocarbyl or tri(C₁-C₂₀-alkyl)silyl; more preferably both R¹⁰ are a C₁-C₆-alkyl, C₃-C₈-cycloalkyl or C₆-aryl group, such as a C₁-C₄-alkyl, C₅-C₆-cycloalkyl or C₆-aryl group.

L is most preferably —Si(CH₃)₂—;

R¹ are each independently the same or are different from each other and are a CH₂-R¹¹ group, with R¹¹ being H or linear or branched C₁-C₆ alkyl group, preferably R¹ are the same and are a CH₂—R¹¹ group, with R¹¹ being H or a linear or branched C₁-C₄-alkyl group, most preferably R¹ are both methyl;

R³, R⁴ and R⁵ are each independently the same or different from each other and are H or a linear or branched C₁-C₆ alkyl group, with the proviso that if there are four or more R³, R⁴ and R⁵ groups different from H present in total, one or more of R³, R⁴ and R⁵ is other than tert butyl, preferably each R³, R⁴ and R⁵ are independently hydrogen, methyl, ethyl, isopropyl or tert.-butyl, especially methyl or tert.-butyl, whereby at least one of R³, R⁴ and R⁵ is different from hydrogen;

one set of R⁷ and R⁸ are part of a C₄-C₂₀ carbon ring system together with the indenyl carbons to which they are attached, preferably a C₅ ring, optionally one carbon atom can be substituted by a nitrogen, sulfur or oxygen atom, and

for the other set of R⁷ and R⁸

R⁸ preferably is the same same or different from each other and is H, a CH₂—R¹² group, with R¹² being H or linear or branched C₁-C₆ alkyl group, most preferably R⁸ preferably is tert.-butyl and

R⁷ is OR¹³, wherein R¹³ is a linear or branched C₁-C₆ alkyl group such as methyl, ethyl, n-propyl, i-propyl, n-butyl, i-butyl, sec.-butyl and tert.-butyl, preferably a linear C₁-C₄-alkyl group, more preferably a C₁-C₂-alkyl group and most preferably methyl; and

R², R⁶ and R⁹ all are H.

Particular complexes of this embodiment include:
Rac-anti-dimethylsilanediyl[2-methyl-4-(4-tert-butylphenyl)-5,6,7-trihydro-s-indacen-1-yl][2-methyl-4-(4-tert-butylphenyl)-5-methoxy-6-tert-butylindenyl zirconium dichloride or dimethyl,
Rac-anti-dimethylsilanediyl[2-iso-butyl-4-(4-tert-butylphenyl)-5,6,7-trihydro-s-indacen-1-yl][2-methyl-4-(4-tert-butylphenyl)-5-methoxy-6-tert-butylindenyl zirconium dichloride or dimethyl,
Rac-anti-dimethylsilanediyl[2-neo-pentyl-4-(4-tert-butylphenyl)-5,6,7-trihydro-s-indacen-1-yl][2-methyl-4-(4-tert-butylphenyl)-5-methoxy-6-tert-butylindenyl zirconium dichloride or dimethyl,
Race-anti-dimethylsilanediyl[2-methyl-4-(3,5-dimethylphenyl)-5,6,7-trihydro-s-indacen-1-yl][2-methyl-4-(3,5-dimethylphenyl)-5-methoxy-6-tert-butylindenyl zirconium dichloride or dimethyl,
Rac-anti-dimethylsilanediyl[2-iso-butyl-4-(3,5-dimethylphenyl)-5,6,7-trihydro-s-indacen-1-yl][2-methyl-4-(3,5-dimethylphenyl)-5-methoxy-6-tert-butylindenyl zirconium dichloride or dimethyl,
Rac-anti-dimethylsilanediyl[2-neo-pentyl-4-(3,5-dimethylphenyl)-5,6,7-trihydro-s-indacen-1-yl][2-methyl-4-(3,5-dimethylphenyl)-5-methoxy-6-tert-butylindenyl zirconium dichloride or dimethyl,
Rac-anti-dimethylsilanediyl[2-methyl-4-(4-tert-butylphenyl)-5,6,7-trihydro-s-indacen-1-yl][2-methyl-4-(3,5-dimethylphenyl)-5-methoxy-6-tert-butylindenyl zirconium dichloride or dimethyl.

For the avoidance of doubt, any narrower definition of a substituent offered above can be combined with any other broad or narrowed definition of any other substituent.

Throughout the disclosure above, where a narrower definition of a substituent is presented, that narrower definition is deemed disclosed in conjunction with all broader and narrower definitions of other substituents in the application.

### Synthesis

The ligands required to form the complexes and hence catalysts of the invention can be synthesised by any process and the skilled organic chemist would be able to devise various synthetic protocols for the manufacture of the necessary ligand materials. For Example WO2007/116034 discloses the necessary chemistry. Synthetic protocols can also generally be found in WO2002/02576, WO2011/135004, WO2012/084961, WO2012/001052, WO2011/076780 and WO2015/158790. The examples section also provides the skilled person with sufficient direction.

### Cocatalyst

To form an active catalytic species it is normally necessary to employ a cocatalyst as is well known in the art.

According to the present invention a cocatalyst system comprising a boron containing cocatalyst as well as an aluminoxane cocatalyst is used in combination with the above defined complex.

The aluminoxane cocatalyst can be one of formula (X):

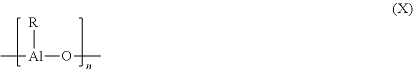

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃-C₁₀-cycloalkyl, C₇-C₁₂-arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (X).

The preferred aluminoxane is methylaluminoxane (MAO). Since the aluminoxanes used according to the invention as cocatalysts are not, owing to their mode of preparation, pure compounds, the molarity of aluminoxane solutions hereinafter is based on their aluminium content.

According to the present invention the aluminoxane cocatalyst is used in combination with a boron containing cocatalyst.

Boron based cocatalysts of interest include those of formula (Z)

BY₃ (Z)

wherein Y independently is the same or can be different and is a hydrogen atom, an alkyl group of from 1 to about 20 carbon atoms, an aryl group of from 6 to about 15 carbon atoms, alkylaryl, arylalkyl, halo alkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris (3,4,5-trifluorophenyl)borane.

Particular preference is given to tris(pentafluorophenyl)borane.

However it is preferred that borates are used, i.e. compounds containing a borate anion. Such ionic cocatalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include: triethylammoniumtetra(phenyl)borate, tributylammoniumtetra(phenyl)borate, trimethylammoniumtetra(tolyl)borate, tributylammoniumtetra(tolyl)borate, tributylammoniumtetra(pentafluorophenyl)borate, tripropylammoniumtetra(dimethylphenyl)borate, tributylammoniumtetra(trifluoromethylphenyl)borate, tributylammoniumtetra(4-fluorophenyl)borate, N,N-dimethylcyclohexylammoniumtetrakis(pentafluorophenyl)borate, N,N-dimethylbenzylammoniumtetrakis(pentafluorophenyl)borate, N,N-dimethylaniliniumtetra(phenyl)borate, N,N-diethylaniliniumtetra(phenyl)borate, N,N-dimethylaniliniumtetrakis(pentafluorophenyl)borate, N,N-di(propyl)ammoniumtetrakis(pentafluorophenyl)borate, di(cyclohexyl)ammoniumtetrakist(pentafluorophenyl)borate, triphenylphosphoniumtetrakis(phenyl)borate, triethylphosphoniumtetrakis(phenyl)borate, diphenylphosphoniumtetrakis(phenyl)borate, tri(methylphenyl)phosphoniumtetrakis(phenyl)borate, tri(dimethylphenyl)phosphoniumtetrakis(phenyl)borate, triphenylcarbeniumtetrakis(pentafluorophenyl)borate, or ferroceniumtetrakis(pentafluorophenyl)borate.

Preference is given to triphenylcarbeniumtetrakis(pentafluorophenyl) borate, N,N-dimethylcyclohexylammoniumtetrakis(pentafluorophenyl)borate or N,N-dimethylbenzylammoniumtetrakis(pentafluorophenyl)borate.

Suitable amounts of cocatalyst will be well known to the skilled man.

The molar ratio of boron to the metal ion of the metallocene may be in the range 0.5:1 to 10:1 mol/mol, preferably 0.8:1 to 10:1, especially 1:1 to 5:1 mol/mol. The molar ratio of Al in the aluminoxane to the metal ion of the metallocene may be in the range 1:1 to 2000:1 mol/mol, preferably 10:1 to 1000:1, and more preferably 50:1 to 500:1 mol/mol.

### Catalyst Manufacture

The catalyst of the invention can be used in supported or unsupported form. The particulate support material used is preferably an organic or inorganic material, such as silica, alumina or zirconia or a mixed oxide such as silica-alumina, in particular silica, alumina or silica-alumina. The use of a silica support is preferred. The skilled man is aware of the procedures required to support a metallocene catalyst. Especially preferably the support is a porous material so that the complex may be loaded into the pores of the support, e.g. using a process analogous to those described in WO94/14856 (Mobil), WO95/12622 (Borealis) and WO2006/097497. The particle size is not critical but is preferably in the range 5 to 200 μm, more preferably 20 to 80 μm. The use of these supports is routine in the art.

In an alternative embodiment, no support is used at all. Such a catalyst can be prepared in solution, for example in an aromatic solvent like toluene, by contacting the metallocene (as a solid or as a solution) with the cocatalyst, for example methylaluminoxane previously dissolved in an aromatic solvent, or can be prepared by sequentially adding the dissolved catalyst components to the polymerization medium.

In one particularly preferred embodiment, no external carrier is used but the catalyst is still presented in solid particulate form. Thus, no external support material, such as inert organic or inorganic carrier, for example silica as described above is employed.

In order to provide the catalyst of the invention in solid form but without using an external carrier, it is preferred if a liquid/liquid emulsion system is used. The process involves forming dispersing catalyst components (i) and (ii) in a solvent, and solidifying said dispersed droplets to form solid particles.

In particular, the method involves preparing a solution of one or more catalyst components; dispersing said solution in an solvent to form an emulsion in which said one or more catalyst components are present in the droplets of the dispersed phase; immobilising the catalyst components in the dispersed droplets, in the absence of an external particulate porous support, to form solid particles comprising the said catalyst, and optionally recovering said particles.

This process enables the manufacture of active catalyst particles with improved morphology, e.g. with a predetermined spherical shape, surface properties and particle size and without using any added external porous support material, such as an inorganic oxide, e.g. silica. By the term “preparing a solution of one or more catalyst components” is meant that the catalyst forming compounds may be combined in one solution which is dispersed to the immiscible solvent, or, alternatively, at least two separate catalyst solutions for each part of the catalyst forming compounds may be prepared, which are then dispersed successively to the solvent.

In a preferred method for forming the catalyst at least two separate solutions for each or part of said catalyst may be prepared, which are then dispersed successively to the immiscible solvent.

More preferably, a solution of the complex comprising the transition metal compound and the cocatalyst is combined with the solvent to form an emulsion wherein that inert solvent forms the continuous liquid phase and the solution comprising the catalyst components forms the dispersed phase (discontinuous phase) in the form of dispersed droplets. The droplets are then solidified to form solid catalyst particles, and the solid particles are separated from the liquid and optionally washed and/or dried. The solvent forming the continuous phase may be immiscible to the catalyst solution at least at the conditions (e. g. temperatures) used during the dispersing step.

The term “immiscible with the catalyst solution” means that the solvent (continuous phase) is fully immiscible or partly immiscible i.e. not fully miscible with the dispersed phase solution.

Preferably said solvent is inert in relation to the compounds of the catalyst system to be produced. Full disclosure of the necessary process can be found in WO03/051934. The inert solvent must be chemically inert at least at the conditions (e.g. temperature) used during the dispersing step. Preferably, the solvent of said continuous phase does not contain dissolved therein any significant amounts of catalyst forming compounds. Thus, the solid particles of the catalyst are formed in the droplets from the compounds which originate from the dispersed phase (i.e. are provided to the emulsion in a solution dispersed into the continuous phase).

The terms “immobilisation” and “solidification” are used herein interchangeably for the same purpose, i.e. for forming free flowing solid catalyst particles in the absence of an external porous particulate carrier, such as silica. The solidification happens thus within the droplets. Said step can be effected in various ways as disclosed in said WO03/051934 Preferably solidification is caused by an external stimulus to the emulsion system such as a temperature change to cause the solidification. Thus in said step the catalyst component (s) remain “fixed” within the formed solid particles.

It is also possible that one or more of the catalyst components may take part in the solidification/immobilisation reaction.

Accordingly, solid, compositionally uniform particles having a predetermined particle size range can be obtained.

Furthermore, the particle size of the catalyst particles of the invention can be controlled by the size of the droplets in the solution, and spherical particles with a uniform particle size distribution can be obtained.

The process is also industrially advantageous, since it enables the preparation of the solid particles to be carried out as a one-pot procedure. Continuous or semicontinuous processes are also possible for producing the catalyst.

### Dispersed Phase

The principles for preparing two phase emulsion systems are known in the chemical field. Thus, in order to form the two phase liquid system, the solution of the catalyst component (s) and the solvent used as the continuous liquid phase have to be essentially immiscible at least during the dispersing step. This can be achieved in a known manner e.g. by choosing said two liquids and/or the temperature of the dispersing step/solidifying step accordingly.

A solvent may be employed to form the solution of the catalyst component (s). Said solvent is chosen so that it dissolves said catalyst component (s). The solvent can be preferably an organic solvent such as used in the field, comprising an optionally substituted hydrocarbon such as linear or branched aliphatic, alicyclic or aromatic hydrocarbon, such as a linear or cyclic alkane, an aromatic hydrocarbon and/or a halogen containing hydrocarbon.

Examples of aromatic hydrocarbons are toluene, benzene, ethylbenzene, propylbenzene, butylbenzene and xylene. Toluene is a preferred solvent. The solution may comprise one or more solvents. Such a solvent can thus be used to facilitate the emulsion formation, and usually does not form part of the solidified particles, but e.g. is removed after the solidification step together with the continuous phase.

Alternatively, a solvent may take part in the solidification, e.g. an inert hydrocarbon having a high melting point (waxes), such as above 40° C., suitably above 70° C., e. g. above 80° C. or 90° C., may be used as solvents of the dispersed phase to immobilise the catalyst compounds within the formed droplets.

In another embodiment, the solvent consists partly or completely of a liquid monomer, e.g. liquid olefin monomer designed to be polymerized in a “prepolymerization” immobilisation step.

### Continuous Phase

The solvent used to form the continuous liquid phase is a single solvent or a mixture of different solvents and may be immiscible with the solution of the catalyst components at least at the conditions (e.g. temperatures) used during the dispersing step. Preferably said solvent is inert in relation to said compounds.

The term “inert in relation to said compounds” means herein that the solvent of the continuous phase is chemically inert, i.e. undergoes no chemical reaction with any catalyst forming component. Thus, the solid particles of the catalyst are formed in the droplets from the compounds which originate from the dispersed phase, i.e. are provided to the emulsion in a solution dispersed into the continuous phase. It is preferred that the catalyst components used for forming the solid catalyst will not be soluble in the solvent of the continuous liquid phase. Preferably, said catalyst components are essentially insoluble in said continuous phase forming solvent. Solidification takes place essentially after the droplets are formed, i.e. the solidification is effected within the droplets e.g. by causing a solidifying reaction among the compounds present in the droplets. Furthermore, even if some solidifying agent is added to the system separately, it reacts within the droplet phase and no catalyst forming components go into the continuous phase.

The term “emulsion” used herein covers both bi- and multiphasic systems.

In a preferred embodiment said solvent forming the continuous phase is an inert solvent including a halogenated organic solvent or mixtures thereof, preferably fluorinated organic solvents and particularly semi, highly or perfluorinated organic solvents and functionalised derivatives thereof. Examples of the above-mentioned solvents are semi, highly or perfluorinated hydrocarbons, such as alkanes, alkenes and cycloalkanes, ethers, e.g. perfluorinated ethers and amines, particularly tertiary amines, and functionalised derivatives thereof. Preferred are semi, highly or perfluorinated, particularly perfluorinated hydrocarbons, e.g. perfluorohydrocarbons of e.g. C₃-C₃₀, such as C₄-C₁₀. Specific examples of suitable perfluoroalkanes and perfluorocycloalkanes include perfluoro-hexane, -heptane, -octane and -(methylcyclohexane). Semi fluorinated hydrocarbons relates particularly to semifluorinated n-alkanes, such as perfluoroalkyl-alkane.

“Semi fluorinated” hydrocarbons also include such hydrocarbons wherein blocks of —C—F and —C—H alternate. “Highly fluorinated” means that the majority of the —C—H units are replaced with —C—F units. “Perfluorinated” means that all —C—H units are replaced with —C—F units. See the articles of A. Enders and G. Maas in “Chemie in unserer Zeit”, 34. Jahrg. 2000, Nr.6, and of Pierandrea Lo Nostro in “Advances in Colloid and Interface Science”, 56 (1995) 245-287, Elsevier Science.

### Dispersing Step

The emulsion can be formed by any means known in the art: by mixing, such as by stirring said solution vigorously to said solvent forming the continuous phase or by means of mixing mills, or by means of ultrasonic wave, or by using a so called phase change method for preparing the emulsion by first forming a homogeneous system which is then transferred by changing the temperature of the system to a biphasic system so that droplets will be formed.

The two phase state is maintained during the emulsion formation step and the solidification step, as, for example, by appropriate stirring.

Additionally, emulsifying agents/emulsion stabilisers can be used, preferably in a manner known in the art, for facilitating the formation and/or stability of the emulsion. For the said purposes e.g. surfactants, e.g. a class based on hydrocarbons (including polymeric hydrocarbons with a molecular weight e.g. up to 10 000 and optionally interrupted with a heteroatom(s)), preferably halogenated hydrocarbons, such as semi- or highly fluorinated hydrocarbons optionally having a functional group selected e.g. from —OH, —SH, NH2, NR″2, —COOH, —COONH2, oxides of alkenes, —CR″═CH2, where R″ is hydrogen, or C1-C20 alkyl, C2-20-alkenyl or C2-20-alkynyl group, oxo-groups, cyclic ethers and/or any reactive derivative of these groups, like alkoxy, or carboxylic acid alkyl ester groups, or, preferably semi-, highly- or perfluorinated hydrocarbons having a functionalised terminal, can be used. The surfactants can be added to the catalyst solution, which forms the dispersed phase of the emulsion, to facilitate the forming of the emulsion and to stabilize the emulsion.

Alternatively, an emulsifying and/or emulsion stabilising aid can also be formed by reacting a surfactant precursor bearing at least one functional group with a compound reactive with said functional group and present in the catalyst solution or in the solvent forming the continuous phase. The obtained reaction product acts as the actual emulsifying aid and or stabiliser in the formed emulsion system. Examples of the surfactant precursors usable for forming said reaction product include e.g. known surfactants which bear at least one functional group selected e.g. from —OH, —SH, NH2, NR″2. —COOH, —COONH2, oxides of alkenes, —CR″═CH2, where R″ is hydrogen, or C1-C20 alkyl, C2-20-alkenyl or C2-20-alkynyl group, oxo-groups, cyclic ethers with 3 to 5 ring atoms, and/or any reactive derivative of these groups, like alkoxy or carboxylic acid alkyl ester groups; e.g. semi-, highly or perfluorinated hydrocarbons bearing one or more of said functional groups. Preferably, the surfactant precursor has a terminal functionality as defined above. The compound reacting with such surfactant precursor is preferably contained in the catalyst solution and may be a further additive or one or more of the catalyst forming compounds. Such compound is e.g. a compound of group 13 (e.g. MAO and/or an aluminium alkyl compound and/or a transition metal compound).

If a surfactant precursor is used, it is preferably first reacted with a compound of the catalyst solution before the addition of the transition metal compound. In one embodiment e.g. a highly fluorinated C1-n (suitably C4-30- or C5-15) alcohol (e.g. highly fluorinated heptanol, octanol or nonanol), oxide (e.g. propenoxide) or acrylate ester is reacted with a cocatalyst to form the “actual” surfactant. Then, an additional amount of cocatalyst and the transition metal compound is added to said solution and the obtained solution is dispersed to the solvent forming the continuous phase. The “actual” surfactant solution may be prepared before the dispersing step or in the dispersed system. If said solution is made before the dispersing step, then the prepared “actual” surfactant solution and the transition metal solution may be dispersed successively (e. g. the surfactant solution first) to the immiscible solvent, or be combined together before the dispersing step.

### Solidification

The solidification of the catalyst component(s) in the dispersed droplets can be effected in various ways, e.g. by causing or accelerating the formation of said solid catalyst forming reaction products of the compounds present in the droplets. This can be effected, depending on the used compounds and/or the desired solidification rate, with or without an external stimulus, such as a temperature change of the system. In a particularly preferred embodiment, the solidification is effected after the emulsion system is formed by subjecting the system to an external stimulus, such as a temperature change. Temperature differences are typically of e.g. 5 to 100° C., such as 10 to 100° C., or 20 to 90° C., such as 50 to 90° C.

The emulsion system may be subjected to a rapid temperature change to cause a fast solidification in the dispersed system. The dispersed phase may e.g. be subjected to an immediate (within milliseconds to few seconds) temperature change in order to achieve an instant solidification of the component (s) within the droplets. The appropriate temperature change, i. e. an increase or a decrease in the temperature of an emulsion system, required for the desired solidification rate of the components cannot be limited to any specific range, but naturally depends on the emulsion system, i. a. on the used compounds and the concentrations/ratios thereof, as well as on the used solvents, and is chosen accordingly. It is also evident that any techniques may be used to provide sufficient heating or cooling effect to the dispersed system to cause the desired solidification.

In one embodiment the heating or cooling effect is obtained by bringing the emulsion system with a certain temperature to an inert receiving medium with significantly different temperature, e. g. as stated above, whereby said temperature change of the emulsion system is sufficient to cause the rapid solidification of the droplets. The receiving medium can be gaseous, e. g. air, or a liquid, preferably a solvent, or a mixture of two or more solvents, wherein the catalyst component (s) is (are) immiscible and which is inert in relation to the catalyst component (s). For instance, the receiving medium comprises the same immiscible solvent used as the continuous phase in the first emulsion formation step.

Said solvents can be used alone or as a mixture with other solvents, such as aliphatic or aromatic hydrocarbons, such as alkanes. Preferably a fluorinated solvent as the receiving medium is used, which may be the same as the continuous phase in the emulsion formation, e. g. perfluorinated hydrocarbon.

Alternatively, the temperature difference may be effected by gradual heating of the emulsion system, e. g. up to 10° C. per minute, preferably 0.5 to 6° C. per minute and more preferably in 1 to 5° C. per minute.

In case a melt of e. g. a hydrocarbon solvent is used for forming the dispersed phase, the solidification of the droplets may be effected by cooling the system using the temperature difference stated above.

Preferably, the “one phase” change as usable for forming an emulsion can also be utilised for solidifying the catalytically active contents within the droplets of an emulsion system by, again, effecting a temperature change in the dispersed system, whereby the solvent used in the droplets becomes miscible with the continuous phase, preferably a fluorous continuous phase as defined above, so that the droplets become impoverished of the solvent and the solidifying components remaining in the “droplets” start to solidify. Thus the immisciblity can be adjusted with respect to the solvents and conditions (temperature) to control the solidification step.

The miscibility of e.g. organic solvents with fluorous solvents can be found from the literature and be chosen accordingly by a skilled person. Also the critical temperatures needed for the phase change are available from the literature or can be determined using methods known in the art, e. g. the Hildebrand-Scatchard-Theorie. Reference is also made to the articles of A. Enders and G. and of Pierandrea Lo Nostro cited above.

Thus according to the invention, the entire or only part of the droplet may be converted to a solid form.

The solid catalyst particles recovered can be used, after an optional washing step, in a polymerization process of an olefin. Alternatively, the separated and optionally washed solid particles can be dried to remove any solvent present in the particles before use in the polymerization step. The separation and optional washing steps can be effected in a known manner, e. g. by filtration and subsequent washing of the solids with a suitable solvent.

The droplet shape of the particles may be substantially maintained. The formed particles may have an average size range of 1 to 500 μm, e.g. 5 to 500 μm, advantageously 5 to 200 μm or 10 to 150 μm. Even an average size range of 5 to 60 μm is possible. The size may be chosen depending on the polymerization the catalyst is used for. Advantageously, the particles are essentially spherical in shape, they have a low porosity and a low surface area.

The formation of solution can be effected at a temperature of 0-100° C., e.g. at 20-80° C. The dispersion step may be effected at −20° C.-100° C., e.g. at about −10-70° C., such as at −5 to 30° C., e.g. around 0° C.

To the obtained dispersion an emulsifying agent as defined above, may be added to improve/stabilise the droplet formation. The solidification of the catalyst component in the droplets is preferably effected by raising the temperature of the mixture, e.g. from 0° C. temperature up to 100° C., e.g. up to 60-90° C., gradually. E.g. in 1 to 180 minutes, e.g. 1-90 or 5-30 minutes, or as a rapid heat change. Heating time is dependent on the size of the reactor.

During the solidification step, which is preferably carried out at about 60 to 100° C., preferably at about 75 to 95° C., (below the boiling point of the solvents) the solvents may preferably be removed and optionally the solids are washed with a wash solution, which can be any solvent or mixture of solvents such as those defined above and/or used in the art, preferably a hydrocarbon, such as pentane, hexane or heptane, suitably heptane. The washed catalyst can be dried or it can be slurried into an oil and used as a catalyst-oil slurry in polymerization process.

All or part of the preparation steps can be done in a continuous manner. Reference is made to WO2006/069733 describing principles of such a continuous or semicontinuous preparation methods of the solid catalyst types, prepared via emulsion/solidification method.

### Catalyst Prepolymerization (“Off-Line Prepolymerization”)

The use of the heterogeneous, non-supported catalysts, (i.e. “self-supported” catalysts) might have, as a drawback, a tendency to dissolve to some extent in the polymerization media, i.e. some active catalyst components might leach out of the catalyst particles during slurry polymerization, whereby the original good morphology of the catalyst might be lost. These leached catalyst components are very active possibly causing problems during polymerization. Therefore, the amount of leached components should be minimized, i.e. all catalyst components should be kept in heterogeneous form.

Furthermore, the self-supported catalysts generate, due to the high amount of catalytically active species in the catalyst system, high temperatures at the beginning of the polymerization which may cause melting of the product material. Both effects, i.e. the partial dissolving of the catalyst system and the heat generation, might cause fouling, sheeting and deterioration of the polymer material morphology.

In order to minimise the possible problems associated with high activity or leaching, it is preferred to “prepolymerize” the catalyst before using it in polymerization process. It has to be noted that prepolymerization in this regard is part of the catalyst preparation process, being a step carried out after a solid catalyst is formed. This catalyst prepolymerization step is not part of the actual polymerization configuration, which might comprise a conventional process prepolymerization step as well. After the catalyst prepolymerization step, a solid catalyst is obtained and used in polymerization.

Catalyst “prepolymerization” takes place following the solidification step of the liquid-liquid emulsion process hereinbefore described. Prepolymerization may take place by known methods described in the art, such as that described in WO 2010/052263, WO 2010/052260 or WO 2010/052264. Preferable embodiments of this aspect of the invention are described herein.

As monomers in the catalyst prepolymerization step preferably alpha-olefins are used. Preferable C₂-C₁₀ olefins, such as ethylene, propylene, 1-butene, 1-pentene, 1-hexene, 4-methyl-1-pentene, 1-heptene, 1-octene, 1-nonene 1-decene, styrene and vinylcyclohexene are used. Most preferred alpha-olefins are ethylene and propylene.

The catalyst prepolymerization may be carried out in gas phase or in an inert diluent, typically oil or fluorinated hydrocarbon, preferably in fluorinated hydrocarbons or mixture of fluorinated hydrocarbons. Preferably perfluorinated hydrocarbons are used. The melting point of such (per)fluorinated hydrocarbons is typically in the range of 0 to 140° C., preferably 30 to 120° C., like 50 to 110° C.

Where the catalyst prepolymerization is done in fluorinated hydrocarbons, the temperature for the prepolymerization step is below 70° C., e.g. in the range of −30 to 70° C., preferably 0-65° C. and more preferably in the range 20 to 55° C.

Pressure within the prepolymerization vessel is preferably higher than atmospheric pressure to minimize the eventual leaching of air and/or moisture into the catalyst vessel. Preferably the pressure is in the range of at least 1 to 15 bar, preferably 2 to 10 bar. The prepolymerization vessel is preferably kept in an inert atmosphere, such as under nitrogen or argon or similar atmosphere. Prepolymerization is continued until the prepolymerization degree (DP) defined as weight of polymer matrix/weight of solid catalyst before prepolymerization step is reached. The degree is below 25, preferably 0.5 to 10.0, more preferably 1.0 to 8.0, most preferably 2.0 to 6.0.

Use of the catalyst prepolymerization step offers the advantage of minimising leaching of catalyst components and thus local overheating.

After prepolymerization, the catalyst can be isolated and stored.

The metallocene catalysts used according to the present invention possess excellent catalyst activity and good comonomer response. The catalysts are also able to provide heterophasic propylene polymers of high weight average molecular weight Mw.

Moreover, the copolymerization behaviour of metallocene catalysts used according to the invention shows a reduced tendency of chain transfer to ethylene. Polymers obtained with the metallocenes of the invention have normal particle morphologies.
In general therefore the invention catalysts can provide:
high activity in bulk propylene polymerization;
very high molecular weight capability;
improved comonomer incorporation in propylene copolymers;
good polymer morphology.

### Polymerization

The present invention relates to a process for producing a copolymer of propylene and at least one comonomer selected from alpha-olefins having from 4 to 12 carbon atoms and optionally ethylene using the specific class of metallocene complexes in combination with a boron containing cocatalyst as well as with an aluminoxane cocatalyst, as defined above or below.

The terms “copolymer of propylene and at least one comonomer selected from alpha-olefins having from 4 to 12 carbon atoms” and “propylene copolymer” are used equally in the following for defining the polymer of propylene produced by the process of the invention.

The term “copolymer of propylene” is also used is the following as abbreviation for the embodiment of the terpolymer of propylene, ethylene and at least one comonomer selected from alpha olefins having from 4 to 12 carbon atoms.

The at least one comonomer is selected from alpha-olefins having from 4 to 12 carbon atoms, preferably from alpha-olefins having from 4 to 10 carbon atoms, more preferably from alpha-olefins having from 4 to 8 carbon atoms, such as 1-butene, 1-hexene and 1-octene. Especially preferred are 1-butene and 1-hexene.

The propylene copolymer can comprise more than one of said comonomer as defined such as two, three or four different of said comonomer, such as 1-butene and 1-hexene.

In one specific embodiment the propylene copolymer includes propylene monomer units, comonomer units selected from at least one, preferably one, alpha-olefin having from 4 to 12 carbon atoms as defined above and ethylene comonomer units.

In this embodiment the propylene copolymer is a terpolymer of propylene, ethylene and at least one comonomer selected from alpha olefins having from 4 to 12 carbon atoms

It is, however, preferred that the propylene copolymer only includes one of said comonomers as defined above.

The process can be a one-stage process in which the propylene copolymer is polymerized in one polymerization reactor.

The process can also be a multistage polymerization process comprising at least two reactors connected in series preferably including a gas phase polymerization step.

Polymerization in the process of the invention may be effected in at least two or more, e.g. 2, 3 or 4, polymerization reactors connected in series of which at least one reactor is preferably a gas phase reactor.

The process may also involve a prepolymerization step. This prepolymerization step is a conventional step used routinely in polymer synthesis and is to be distinguished from the catalyst prepolymerization step discussed above.

Preferably, the process of the invention employs one reactor or two reactors wherein for the latter case at least one reactor of the two reactors is a gas phase reactor. For polymerizing the propylene copolymer the process of the invention preferably employs one reactor, suitably for producing a unimodal propylene copolymer, or two reactors connected in series wherein at least one reactor is a gas phase reactor, suitably for producing a bimodal propylene copolymer. For the case of producing a multimodal propylene copolymer the process according to the invention can also employ three or more reactors connected in series wherein at least one reactor is a gas phase reactor. Ideally the process of the invention for polymerizing the propylene copolymer employs a first reactor operating in bulk and optionally a second reactor being a gas phase reactor. Any optional additional subsequent reactor after the second reactor is preferably a gas phase reactor.

The process may also utilise a prepolymerization step. Bulk reactions may take place in a loop reactor.

For bulk and gas phase copolymerization reactions, the reaction temperature used will generally be in the range 60 to 115° C. (e.g. 70 to 90° C.), the reactor pressure will generally be in the range 10 to 25 bar for gas phase reactions with bulk polymerization operating at higher pressures. The residence time will generally be 0.25 to 8 hours (e.g. 0.5 to 4 hours). The gas used will be the monomer optionally as mixture with a non-reactive gas such as nitrogen or propane. It is a particular feature of the invention that polymerization takes place at temperatures of at least 60° C. Generally the quantity of catalyst used will depend upon the nature of the catalyst, the reactor types and conditions and the properties desired for the polymer product. As is well known in the art hydrogen can be used for controlling the molecular weight of the polymer.

Splits between the various reactors can vary. When two reactors are used, splits are generally in the range of 30 to 70 wt % to 70 to 30 wt % bulk to gas phase, preferably 40 to 60 to 60 to 40 wt %. Where three reactors are used, it is preferred that each reactor preferably produces at least 20 wt % of the polymer, such as at least 25 wt %. The sum of the polymer produced in gas phase reactors should preferably exceed the amount produced in bulk.

In one embodiment of the present invention the process comprises the following steps:
a) introducing propylene monomer units, alpha-olefin comonomer units having from 4 to 12 carbon atoms, optionally ethylene comonomer units, and hydrogen into a polymerization reactor;
b) polymerizing the propylene monomer units, optional ethylene comonomer units, and alpha-olefin comonomer units having from 4 to 12 carbon atoms to form a copolymer of propylene and at least one comonomer selected alpha-olefins from having from 4 to 12 carbon atoms in the presence of the single-site catalyst.

This embodiment is especially suitable for the production of a unimodal propylene copolymer.

In another embodiment the process may further comprise the following steps:
c) transferring the polymerization mixture from process step b) comprising the copolymer of propylene and at least one comonomer selected alpha-olefins from having from 4 to 12 carbon atoms and the single site catalyst into a second polymerization reactor;
d) introducing propylene monomer units, optionally alpha-olefin comonomer units having from 4 to 12 carbon atoms and hydrogen into said second polymerization reactor;
e) polymerizing the propylene monomer units and optionally alpha-olefin comonomer units having from 4 to 12 carbon atoms to form a second polymer of propylene which is selected from a propylene homopolymer or a copolymer of propylene and at least one comonomer alpha-olefin having from 4 to 12 carbon atoms in the presence of the copolymer of propylene and at least one comonomer selected alpha-olefins from having from 4 to 12 carbon atoms of process step b) in the presence of the single-site catalyst.

Said embodiment is especially suitable for the production of a bimodal or multimodal propylene copolymer.

Thereby, in the second polymerization reactor a propylene homopolymer can be polymerized so that the propylene copolymer polymerized according to the process of said embodiment comprises a copolymer component of propylene and at least one comonomer selected alpha-olefins from having from 4 to 12 carbon atoms and a propylene homopolymer component.

It is, however, preferred that in the second polymerization reactor a copolymer component of propylene and at least one comonomer selected alpha-olefins from having from 4 to 12 carbon atoms is polymerized so that the propylene copolymer polymerized according to the process of said embodiment comprises two copolymer components of propylene and at least one comonomer selected alpha-olefins from having from 4 to 12 carbon atoms.

The two copolymer components of propylene and at least one comonomer selected alpha-olefins from having from 4 to 12 carbon atoms can comprise the same comonomer or different comonomers.

The two copolymer components of propylene and at least one comonomer selected alpha-olefins from having from 4 to 12 carbon atoms can differ in their molecular weight, such as their weight average molecular weight Mw and their melt flow rate MFR₂.

In the embodiment of a terpolymer of propylene, ethylene and at least one comonomer selected alpha-olefins from having from 4 to 12 carbon atoms the process as described above can be adjusted as such that in one of the two process steps b) or e) the alpha-olefin comonomer units having from 4 to 12 carbon atoms are replaced with ethylene monomer units so that in said polymerization stage a copolymer of propylene and ethylene is polymerized.

Preferably, in the first polymerization reactor of the embodiments discussed above in process step b) the molar ratio of hydrogen to propylene, [H₂/C₃] is at least 0.18 mol/kmol, more preferably at least 0.20 mol/kmol.

It has been found that despite the presence of hydrogen during the polymerization process propylene copolymers with a high weight average molecular weight and a low melt flow rate can be produced. Additionally, a high [H₂/C₃] ratio increases the catalyst activity and productivity.

It is further preferred that in the first polymerization reactor of the embodiments discussed above in process step b) the molar ratio of alpha-olefin comonomer to propylene, C₄₋₁₂/C₃ is from 1.0 to 100 mol/kmol, more preferably from 5 to 75 mol/kmol, most preferably from 10 to 60 mol/kmol.

The molar ratio of alpha-olefin comonomer to propylene, C₄₋₁₂/C₃, in any subsequent polymerization reactor for polymerizing a propylene copolymer can be in the same range as for the first polymerization reactor as discussed above.

During polymerization the single site catalyst preferably has a catalyst activity, determined with respect to the unprepolymerized catalyst, of preferably at least 35 kg of propylene polymer per g of the unprepolymerized catalyst per hr of polymerization (kg/g_{unprepolym. cat}/h), more preferably at least 45 kg/g_{unprepolym. cat}/h, most preferably at least 50 kg/g_{unprepolym. cat}/h. Usually the catalyst activity does not exceed 150 kg/g_{unprepolym. cat}/h.

During polymerization the single site catalyst preferably has an overall catalyst productivity, determined with respect to the unprepolymerized catalyst, is preferably at least 40 kg of propylene polymer per g of the unprepolymerized catalyst (kg/g_{unprepolym. cat}), more preferably at least 55 kg/g_{unprepolym. cat}, most preferably at least 70 kg/g_{unprepolym. cat.} Usually the overall catalyst productivity does not exceed 200 kg/g_{unprepolym. cat}.

The overall catalyst productivity is determined over all polymerization stages.

### Polymer

The present invention also relates to a polymer of propylene and at least one comonomer selected from alpha-olefins having from 4 to 12 carbon atoms or a terpolymer of propylene, ethylene and at least one comonomer selected from alpha olefins having from 4 to 12 carbon atoms obtainable from the process according to the invention as described above and below.

Thereby, the copolymer of propylene and at least one comonomer selected from alpha olefins having from 4 to 12 carbon atoms or terpolymer of propylene, ethylene and at least one comonomer selected from alpha olefins having from 4 to 12 carbon atoms follows the following relation (A) in behalf of its polymerization process:

MFR₂/[H₂/C₃]≤55 [g/10 min/mol/kmol] (A)

with
MFR₂ melt flow rate in g/10 min of the copolymer of propylene and at least one comonomer selected from alpha olefins having from 4 to 12 carbon atoms or terpolymer of propylene, ethylene and at least one comonomer selected from alpha olefins having from 4 to 12 carbon atoms, determined according to ISO 1133 at a temperature of 230° C. and a load of 2.16 kg;
[H₂/C₃] molar ratio of hydrogen to propylene in mol/kmol in process step b) wherein the molar ratio of hydrogen to propylene, [H₂/C₃], in process step b) is at least 0.18 mol/kmol.

Preferably the copolymer of propylene and at least one comonomer selected from alpha olefins having from 4 to 12 carbon atoms or terpolymer of propylene, ethylene and at least one comonomer selected from alpha olefins having from 4 to 12 carbon atoms follows the following relation (B) in behalf of its polymerization process:

Mw·[H₂/C₃]≥44 kg/kmol (B)
Mw=weight average molecular weight in kg/mol of the copolymer of propylene and at least one comonomer selected from alpha olefins having from 4 to 12 carbon atoms or terpolymer of propylene, ethylene and at least one comonomer selected from alpha olefins having from 4 to 12 carbon atoms; and
[H₂/C₃] molar ratio of hydrogen to propylene in mol/kmol in process step b).

The two relations (A) and (B) show that even at high molar ratios of hydrogen to propylene copolymers with low melt flow rates (and also high weight average molecular weights) can be obtained with the process of the invention.

The at least one comonomer is selected from alpha-olefins having from 4 to 12 carbon atoms, preferably from alpha-olefins having from 4 to 10 carbon atoms, more preferably from alpha-olefins having from 4 to 8 carbon atoms, such as 1-butene, 1-hexene and 1-octene. Especially preferred are 1-butene and 1-hexene.

The propylene copolymer can comprise more than one of said comonomer as defined such as two, three or four different of said comonomer, such as 1-butene and 1-hexene.

In one specific embodiment the propylene copolymer includes propylene monomer units, comonomer units selected from at least one, preferably one, alpha-olefin having from 4 to 12 carbon atoms as defined above and ethylene comonomer units. In this embodiment the propylene copolymer is a terpolymer of propylene, ethylene and at least one comonomer selected from alpha olefins having from 4 to 12 carbon atoms.

It is, however, preferred that the propylene copolymer only includes one of said comonomers as defined above.

Thus, it is particularly preferred that the copolymer of propylene and at least one comonomer selected from alpha olefins having from 4 to 12 carbon atoms is a copolymer of propylene and 1-butene or a copolymer of propylene and 1-hexene.

Preferably the copolymer of propylene and at least one comonomer selected from alpha olefins having from 4 to 12 carbon atoms has a comonomer content of from 0.1 to 5.0 mol %, more preferably of from 0.2 to 4.0 mol %, still more preferably of from 0.3 to 3.0 mol % and most preferably of from 0.5 to 2.5 mol %, based on the total weight of the copolymer of propylene and at least one comonomer selected from alpha olefins having from 4 to 12 carbon atoms.

For the embodiment of the terpolymer of propylene, ethylene and at least one comonomer selected from alpha olefins having from 4 to 12 carbon atoms the total comonomer content of comonomer selected from alpha olefins having from 4 to 12 carbon atoms and ethylene is preferably in the range of from 0.1 to 5.0 mol %, more preferably of from 0.2 to 4.0 mol %, still more preferably of from 0.3 to 3.0 mol % and most preferably of from 0.5 to 2.5 mol %, based on the total weight of the terpolymer of propylene, ethylene and at least one comonomer selected from alpha olefins having from 4 to 12 carbon atoms.

The propylene copolymer preferably has a melt flow rate MFR₂ of from 0.05 to 500 g/10 min, more preferably in the range of 0.20 to 200.0 g/10 min more preferably in the range of 0.50 to 150.0 g/10 min.

Further, the propylene copolymer preferably has a weight average molecular weight Mw of at least 100 kg/mol, preferably at least 200 kg/mol and more preferably of at least 230 kg/mol up to 2 000 kg/mol, preferably up to 1 500 kg/mol and more preferably up to 1000 kg/mol, like up to 500 kg/mol depending on the use and amount of hydrogen used as Mw regulating agent.

Still further, the molecular weight distribution (MWD; M_{w}/Mₙ as measured with GPC) of the propylene copolymer can be relatively broad, i.e. the M_{w}/Mₙ can be up to 7.0. Preferably the M_{w}/Mₙ is in a range of from 2.5 to 7.0, more preferably from 2.8 to 6.8 and even more preferably from 2.9 to 6.5.

In a preferred embodiment the copolymer of propylene and at least one comonomer selected from alpha olefins having from 4 to 12 carbon atoms is a random copolymer of propylene and at least one comonomer selected from alpha olefins having from 4 to 12 carbon atoms.

In another preferred embodiment the terpolymer of propylene, ethylene and at least one comonomer selected from alpha olefins having from 4 to 12 carbon atoms is a random terpolymer of propylene, ethylene and at least one comonomer selected from alpha olefins having from 4 to 12 carbon atoms.

### Use

The present invention further relates to the use of a single-site catalyst comprising
(i) a complex of formula (I)

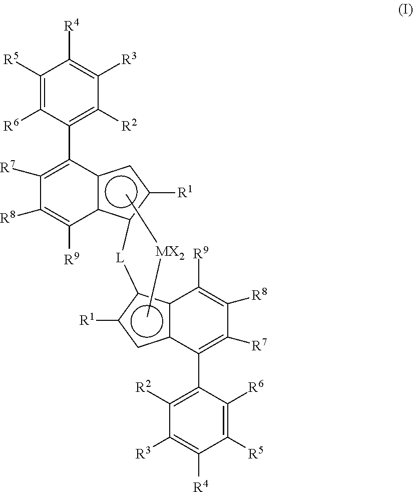

wherein
M is zirconium or hafnium;
each X independently is a sigma-donor ligand
L is a bridge of formula -(ER¹⁰₂)_{y}—;
y is 1 or 2;
E is C or Si;
each R¹⁰ is independently a C₁-C₂₀-hydrocarbyl group, tri(C₁-C₂₀ alkyl)silyl group, C₆-C₂₀ aryl group, C₇-C₂₀ arylalkyl group or C₇-C₂₀ alkylaryl group or L is an alkylene group such as methylene or ethylene;
R¹ are each independently the same or are different from each other and are a CH₂—R¹¹ group, with R¹¹ being H or linear or branched C₁-C₆ alkyl group, C₃-C₈ cycloalkyl group, C₆-C₁₀ aryl group;
R³, R⁴ and R⁵ are each independently the same or different from each other and are H or a linear or branched C₁-C₆ alkyl group, C₇-C₂₀ arylalkyl group, C₇-C₂₀ alkylaryl group, or C₆-C₂₀ aryl group with the proviso that if there are four or more R³, R⁴ and R⁵ groups different from H present in total, one or more of R³, R⁴ and R⁵ is other than tert butyl;
R⁷ and R⁸ are each independently the same or different from each other and are H, a CH₂—R¹² group, with R¹² being H or linear or branched C₁-C₆ alkyl group, SiR¹³₃, GeR¹³₃, OR¹³, SR¹³, NR¹³₂,
wherein
R¹³ is a linear or branched C₁-C₆ alkyl group, C₇-C₂₀ alkylaryl group and C₇-C₂₀ arylalkyl group or C₆-C₂₀ aryl group,
and/or
R⁷ and R⁸ are part of a C₄-C₂₀ carbon ring system together with the indenyl carbons to which they are attached, preferably a C₅ ring, optionally one carbon atom can be substituted by a nitrogen, sulfur or oxygen atom; and
R², R⁶ and R⁹ all are H; and
(ii) a cocatalyst system comprising a boron containing cocatalyst and an aluminoxane cocatalyst

for the production of a copolymer of propylene and at least one comonomer selected from alpha olefins having from 4 to 12 carbon atoms or a terpolymer of propylene, ethylene and at least one comonomer selected from alpha olefins having from 4 to 12 carbon atoms as defined above or below.

Thereby, the copolymer of propylene and at least one comonomer selected from alpha olefins having from 4 to 12 carbon atoms and the terpolymer of propylene, ethylene and at least one comonomer selected from alpha olefins having from 4 to 12 carbon atoms include all embodiments as described above or below.

The invention will now be illustrated by reference to the following non-limiting Examples

### Analytical Tests

### Measurement Methods:

### Al and Zr Determination (ICP-Method)

The elementary analysis of a catalyst was performed by taking a solid sample of mass, M, cooling over dry ice. Samples were diluted up to a known volume, V, by dissolving in nitric acid (HNO₃, 65%, 5% of V) and freshly deionised (DI) water (5% of V). The solution was then added to hydrofluoric acid (HF, 40%, 3% of V), diluted with DI water up to the final volume, V, and left to stabilise for two hours. The analysis was run at room temperature using a Thermo Elemental iCAP 6300 Inductively Coupled Plasma—Optical Emmision Spectrometer (ICP-OES) which was calibrated using a blank (a solution of 5% HNO₃, 3% HF in DI water), and 6 standards of 0.5 ppm, 1 ppm, 10 ppm, 50 ppm, 100 ppm and 300 ppm of Al, with 0.5 ppm, 1 ppm, 5 ppm, 20 ppm, 50 ppm and 100 ppm of Hf and Zr in solutions of 5% HNO3, 3% HF in DI water.

Immediately before analysis the calibration is ‘resloped’ using the blank and 100 ppm Al, 50 ppm Hf, Zr standard, a quality control sample (20 ppm Al, 5 ppm Hf, Zr in a solution of 5% HNO3, 3% HF in DI water) is run to confirm the reslope. The QC sample is also run after every 5th sample and at the end of a scheduled analysis set.

The content of hafnium was monitored using the 282.022 nm and 339.980 nm lines and the content for zirconium using 339.198 nm line. The content of aluminium was monitored via the 167.079 nm line, when Al concentration in ICP sample was between 0-10 ppm (calibrated only to 100 ppm) and via the 396.152 nm line for Al concentrations above 10 ppm.

The reported values are an average of three successive aliquots taken from the same sample and are related back to the original catalyst by inputting the original mass of sample and the dilution volume into the software.

In the case of analysing the elemental composition of prepolymerized catalysts, the polymeric portion is digested by ashing in such a way that the elements can be freely dissolved by the acids. The total content is calculated to correspond to the weight % for the prepolymerized catalyst.

### GPC:

Molecular weight averages, molecular weight distribution, and polydispersity index (Mₙ, M_{w}, M_{w}/Mₙ)

Molecular weight averages (Mw, Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-4:2003 and ASTM D 6474-99.

A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/L 2,6-Di tert butyl-4-methyl-phenol) as solvent at 160° C. and at a constant flow rate of 1 mL/min. 200 μL of sample solution were injected per analysis. The column set was calibrated using universal calibration (according to ISO 16014-2:2003) with at least 15 narrow MWD polystyrene (PS) standards in the range of 0.5 kg/mol to 11 500 kg/mol. Mark Houwink constants for PS, PE and PP used are as described per ASTM D 6474-99. All samples were prepared by dissolving 5.0-9.0 mg of polymer in 8 mL (at 160° C.) of stabilized TCB (same as mobile phase) for 2.5 hours for PP or 3 hours for PE at max. 160° C. under continuous gentle shaking in the autosampler of the GPC instrument

### Quantification of Copolymer Microstructure by ¹³C-NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probehead at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification (Klimke, K., Parkinson, M., Piel, C., Kaminsky, W., Spiess, H. W., Wilhelm, M., Macromol. Chem. Phys. 2006; 207:382.; Parkinson, M., Klimke, K., Spiess, H. W., Wilhelm, M., Macromol. Chem. Phys. 2007; 208:2128.; Castignolles, P., Graf, R., Parkinson, M., Wilhelm, M., Gaborieau, M., Polymer 50 (2009) 2373). Standard single-pulse excitation was employed utilising the NOE at short recycle delays of 3 s (Pollard, M., Klimke, K., Graf, R., Spiess, H. W., Wilhelm, M., Sperber, O., Piel, C., Kaminsky, W., Macromolecules 2004; 37:813.; Klimke, K., Parkinson, M., Piel, C., Kaminsky, W., Spiess, H. W., Wilhelm, M., Macromol. Chem. Phys. 2006; 207:382.) and the RS-HEPT decoupling scheme (Filip, X., Tripon, C., Filip, C., J. Mag. Resn. 2005, 176, 239.; Griffin, J. M., Tripon, C., Samoson, A., Filip, C., and Brown, S. P., Mag. Res. in Chem. 2007 45, 51, S198). A total of 16384 (16 k) transients were acquired per spectra.

Quantitative ¹³C{¹H} NMR spectra were processed, integrated and relevant quantitative properties determined from the integrals. All chemical shifts are internally referenced to the methyl isotactic pentad (mmmm) at 21.85 ppm.

### Basic Co-Butene Content Spectral Analysis Method

Characteristic signals corresponding to the incorporation of 1-butene were observed and the comonomer content quantified in the following way.

The amount 1-butene incorporated in PPBPP isolated sequences was quantified using the integral of the αB2 sites at 43.6 ppm accounting for the number of reporting sites per comonomer:

B=Iα/2

The amount of 1-butene incorporated in PPBBPP double consecutively sequences was quantified using the integral of the ααB2B2 site at 40.5 ppm accounting for the number of reporting sites per comonomer:

BB=2*Iαα

When double consecutive incorporation was observed the amount of 1-butene incorporated in PPBPP isolated sequences needed to be compensated due to the overlap of αB2 and αB2B2 signals at 43.9 ppm:

B=(Iα−2*Iαα)/2

The total 1-butene content was calculated based on the sum of isolated and consecutively incorporated 1-butene:

Bₜₒₜₐₗ=B+BB

The amount of propene was quantified based on the main Sαα methylene sites at 46.7 ppm and compensating for the relative amount of αB2 and ααB2B2 methylene unit of propene not accounted for (note B and BB count number of butane monomers per sequence not the number of sequences):

PₜₒₜₐₗIₛαα+B+BB/2

With characteristic signals corresponding to regio defects observed (Resconi, L., Cavallo, L., Fait, A., Piemontesi, F., Chem. Rev. 2000, 100, 1253), the compensation for misinserted propylene units was used for Ptotal.

In case of 2,1-erythro mis-insertions presence the signal from ninth carbon (S₂₁ₑ₉) of this microstructure element (Resconi, L., Cavallo, L., Fait, A., Piemontesi, F., Chem. Rev. 2000, 100, 1253) with chemical shift at 42.5 ppm was chosen for compensation. In this case:

Pₜₒₜₐₗ=Iₛαα+B+BB/2+3*I(S₂₁ₑ₉)

The total mole fraction of 1-butene in the polymer was then calculated as:

fB=(Bₜₒₜₐₗ/(Bₜₒₜₐₗ+Pₜₒₜₐₗ)

The total comonomer incorporation of 1-butene in mole percent was calculated from the mole fraction in the usual manner:

B[mol %]=100*fB

The total comonomer incorporation of 1-butene in weight percent was calculated from the mole fraction in the standard manner:

B[wt %]=100*(fB*56.11)/((fB*56.11)+((1−fB)*42.08))

### Basic Co-Hexene Content Spectral Analysis Method

Characteristic signals corresponding to the incorporation of 1-hexene were observed and the comonomer content quantified in the following way.

The amount 1-hexene incorporated in PPHPP isolated sequences was quantified using the integral of the αH2 sites at 44.2 ppm accounting for the number of reporting sites per comonomer:

H=Iα/2

With no other signals indicative of other comonomer sequences, i.e. consecutive comonomer incorporation, observed the total 1-hexene comonomer content was calculated based solely on the amount of isolated 1-hexene sequences:

Hₜₒₜₐₗ=H

The amount of propene was quantified based on the main Sαα methylene sites at 46.7 ppm and compensating for the relative amount of αB2 and ααB2B2 methylene unit of propene not accounted for (note B and BB count number of butane monomers per sequence not the number of sequences):

Pₜₒₜₐₗ=Iₛαα+H

With characteristic signals corresponding to regio defects observed (Resconi, L., Cavallo, L., Fait, A., Piemontesi, F., Chem. Rev. 2000, 100, 1253), the compensation for misinserted propylene units was used for Ptotal.

In case of 2,1-erythro mis-insertions presence the signal from ninth carbon (S₂₁ₑ₉) of this microstructure element (Resconi, L., Cavallo, L., Fait, A., Piemontesi, F., Chem. Rev. 2000, 100, 1253) with chemical shift at 42.5 ppm was chosen for compensation. In this case:

Pₜₒₜₐₗ=Iₛαα+H+3*I(S₂₁ₑ₉)

The total mole fraction of 1-hexene in the polymer was then calculated as:

fH=(Hₜₒₜₐₗ/(Hₜₒₜₐₗ+Pₜₒₜₐₗ)

The total comonomer incorporation of 1-hexene in mole percent was calculated from the mole fraction in the usual manner:

H[mol %]=100*fH

The total comonomer incorporation of 1-hexene in weight percent was calculated from the mole fraction in the standard manner:

H[wt %]=100*(fH*84.17)/((fH*84.17)+((1−fH)*42.08))

### Melt Flow Rate (MFR)

The melt flow rate (MFR) or melt index (MI) is measured according to ISO 1133.

Where different loads can be used, the load is normally indicated as the subscript, for instance, MFR₂ which indicates 2.16 kg load. The temperature is selected according to ISO 1133 for the specific polymer, for instance, 230° C. for polypropylene. Thus, for polypropylene MFR₂ is measured at 230° C. temperature and under 2.16 kg load.

### Xylene Solubles (XS)

The xylene soluble (XS) fraction as defined and described in the present invention is determined in line with ISO 16152 as follows: 2.0 g of the polymer were dissolved in 250 ml p-xylene at 135° C. under agitation. After 30 minutes, the solution was allowed to cool for 15 minutes at ambient temperature and then allowed to settle for 30 minutes at 25+/−0.5° C. The solution was filtered with filter paper into two 100 ml flasks. The solution from the first 100 ml vessel was evaporated in nitrogen flow and the residue dried under vacuum at 90° C. until constant weight is reached. The xylene soluble fraction (percent) can then be determined as follows: XS %=(100·m·Vo)/(mo·v); mo=initial polymer amount (g); m=weight of residue (g); Vo=initial volume (ml); v=volume of analysed sample (ml).

### Catalyst Activity

The catalyst activity was calculated on the basis of following formula:

$$Catalyst Activity ( kg - PP \text{/} g - Cat \text{/} h ) = \frac{amount of polymer produced ( kg )}{catalyst loading ( g ) \times polymerization time ( h )}$$

### Productivity

Overall productivity was calculated as

$$Catalyst Productivity ( kg - PP \text{/} g ) = \frac{amount of polymer produced ( kg )}{catalyst loading ( g )}$$

For both the catalyst activity and the productivity the catalyst loading is either the grams of prepolymerized catalyst or the grams of metallocene present in that amount of prepolymerized catalyst.

Prepolymerization degree (DP): weight of polymer/weight of solid catalyst before prepolymerization step

The composition of the catalysts (before the off-line prepolymerization step) has been determined by ICP as described above. The metallocene content of the prepolymerized catalysts has been calculated from the ICP data as follows:

$$\begin{matrix} \frac{Al}{Zr} ( mol \text{/} mol ) = \frac{Al ( wt \% , ICP ) \text{/} 26 , 98}{Zr ( wt \% , ICP ) \text{/} 91 , 22} & Equation 1 \\ Zr ( mol \% ) = \frac{100}{\frac{Al}{Zr} ( mol \text{/} mol ) + 1} & Equation 2 \\ MC ( wt \% , unprepol . cat ) = \frac{100 \times ( Zr , mol \% \times MwMC )}{Zr , mol \% \times MwMC + ( 100 - Zr , mol \% ) \times MwMAO} & Equation 3 \\ MC ( wt \% , prepolymerized cat ) = \frac{MC ( wt \% , unprepolymerized cat )}{DP + 1} & Equation 4\end{matrix}$$

### EXAMPLES

### Metallocene Synthesis

### Materials Used for Complex Preparation:

2,6-Dimethylaniline (Acros), 1-bromo-3,5-dimethylbenzene (Acros), 1-bromo-3,5-di-tert-butylbenzene (Acros), bis(2,6-diisopropylphenyl)imidazolium chloride (Aldrich), triphenylphosphine (Acros), NiCl₂(DME) (Aldrich), dichlorodimethylsilane (Merck), ZrCl₄ (Merck), trimethylborate (Acros), Pd(OAc)₂ (Aldrich), NaBH₄ (Acros), 2.5 M nBuLi in hexanes (Chemetal), CuCN (Merck), magnesium turnings (Acros), silica gel 60, 40-63 μm (Merck), bromine (Merck), 96% sulfuric acid (Reachim), sodium nitrite (Merck), copper powder (Alfa), potassium hydroxide (Merck), K₂CO₃ (Merck), 12 M HCl (Reachim), TsOH (Aldrich), MgSO₄ (Merck), Na₂CO₃ (Merck), Na₂SO₄ (Akzo Nobel), methanol (Merck), diethyl ether (Merck), 1,2-dimethoxyethane (DME, Aldrich), 95% ethanol (Merck), dichloromethane (Merck), hexane (Merck), THF (Merck), and toluene (Merck) were used as received. Hexane, toluene and dichloromethane for organometallic synthesis were dried over molecular sieves 4A (Merck). Diethyl ether, THF, and 1,2-dimethoxyethane (Aldrich) for organometallic synthesis were distilled over sodium benzophenoneketyl. CDCl₃ (Deutero GmbH) and CD₂Cl₂ (Deutero GmbH) were dried over molecular sieves 4A. 4-Bromo-6-tert-butyl-5-methoxy-2-methylindan-1-one was obtained as described in WO 2013/007650.

The following complexes as shown below were used in preparing catalysts for the examples:

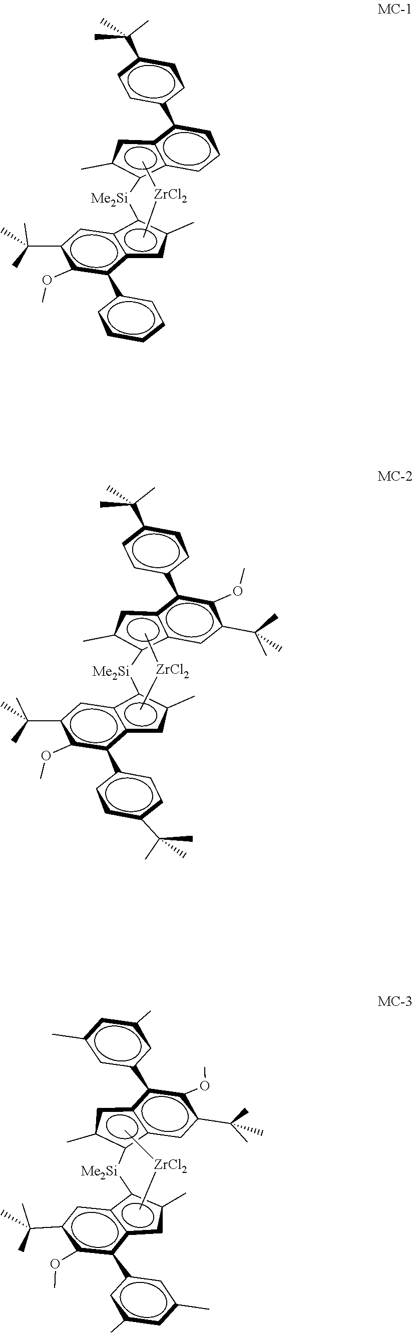

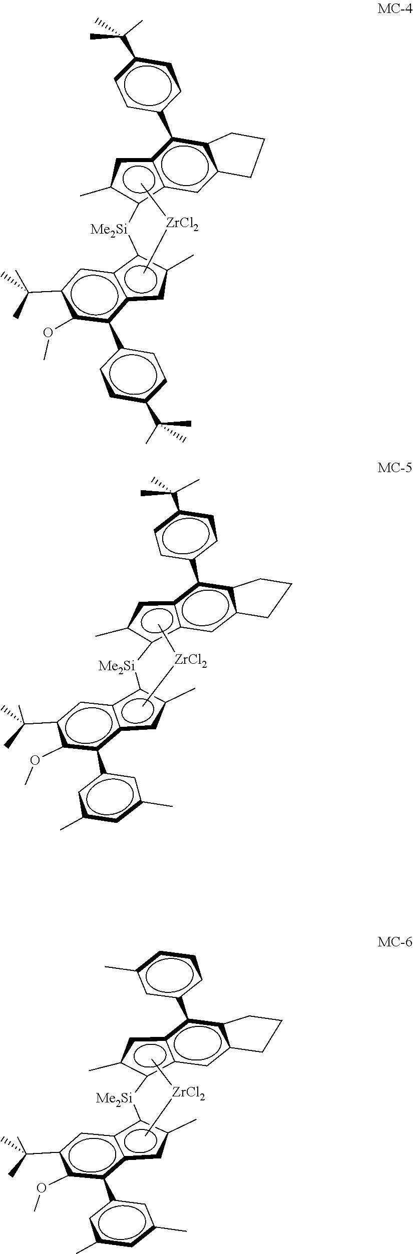

### Synthesis of Metallocene MC-1

The metallocene MC-1 (rac-anti-dimethylsilandiyl(2-methyl-4-phenyl-5-methoxy-6-tert-butyl-indenyl)(2-methyl-4-(4-tert-butylphenyl)indenyl)zirconium dichloride) has been synthesized as described in WO 2013/007650.

### Synthesis of Metallocene MC-2

### 4-(4-tert-Butylphenyl)-1-methoxy-2-methyl-1,2,3,5,6,7-hexahydro-s-indacene

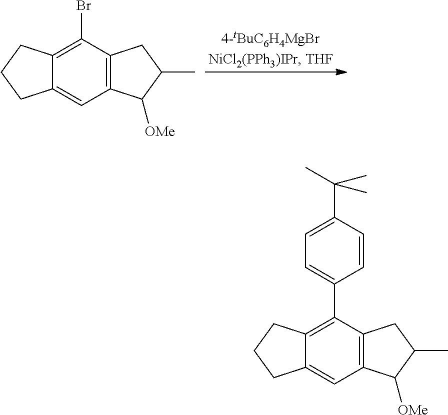 [SMILES: COC1c2cc3c(c(Br)c2CC1C)CCC3 ; COC1c2cc3c(c(-c4ccc(C(C)(C)C)cc4)c2CC1C)CCC3]

The precursor 4-bromo-1-methoxy-2-methyl-1,2,3,5,6,7-hexahydro-s-indacene was made according to the procedure described in WO2015/158790 A2 (pp 26-29).

To a mixture of 1.5 g (1.92 mmol, 0.6 mol. %) of NiCl₂(PPh₃)IPr and 89.5 g (318.3 mmol) of 4-bromo-1-methoxy-2-methyl-1,2,3,5,6,7-hexahydro-s-indacene, 500 ml (500 mmol, 1.57 equiv) of 1.0 M 4-tert-butylphenylmagnesium bromide in THF was added. The resulting solution was refluxed for 3 h, then cooled to room temperature, and 1000 ml of 0.5 M HCl was added. Further on, this mixture was extracted with 1000 ml of dichloromethane, the organic layer was separated, and the aqueous layer was extracted with 250 ml of dichloromethane. The combined organic extract was evaporated to dryness to give a greenish oil. The title product was isolated by flash-chromatography on silica gel 60 (40-63 μm; eluent: hexanes-dichloromethane=3:1, vol., then 1:3, vol.). This procedure gave 107 g (ca. 100%) of 1-methoxy-2-methyl-4-(4-tert-butylphenyl)-1,2,3,5,6,7-hexahydro-s-indacene as a white solid mass.

Anal. calc. for C₂₄H₃₀O: C, 86.18; H, 9.04. Found: C, 85.99; H, 9.18.

¹H NMR (CDCl₃), syn-isomer: δ 7.42-7.37 (m, 2H), 7.25-7.20 (m, 3H), 4.48 (d, J=5.5 Hz, 1H), 3.44 (s, 3H), 2.99-2.47 (m, 7H), 2.09-1.94 (m, 2H), 1.35 (s, 9H), 1.07 (d, J=6.9 Hz, 3H); Anti-isomer: δ 7.42-7.37 (m, 2H), 7.25-7.19 (m, 3H), 4.39 (d, J=3.9 Hz, 1H), 3.49 (s, 3H), 3.09 (dd, J=15.9 Hz, J=7.5 Hz, 1H), 2.94 (t, J=7.3 Hz, 2H), 2.78 (tm, J=7.3 Hz, 2H), 2.51-2.39 (m, 1H), 2.29 (dd, J=15.9 Hz, J=5.0 Hz, 1H), 2.01 (quip, J=7.3 Hz, 2H), 1.36 (s, 9H), 1.11 (d, J=7.1 Hz, 3H). ¹³C{¹H} NMR (CDCl₃), syn-isomer: δ 149.31, 142.71, 142.58, 141.46, 140.03, 136.71, 135.07, 128.55, 124.77, 120.02, 86.23, 56.74, 39.41, 37.65, 34.49, 33.06, 32.45, 31.38, 25.95, 13.68; Anti-isomer: δ 149.34, 143.21, 142.90, 140.86, 139.31, 136.69, 135.11, 128.49, 124.82, 119.98, 91.53, 56.50, 40.12, 37.76, 34.50, 33.04, 32.40, 31.38, 25.97, 19.35.

### 4-(4-tert-Butylphenyl)-6-methyl-1,2,3,5-tetrahydro-s-indacene

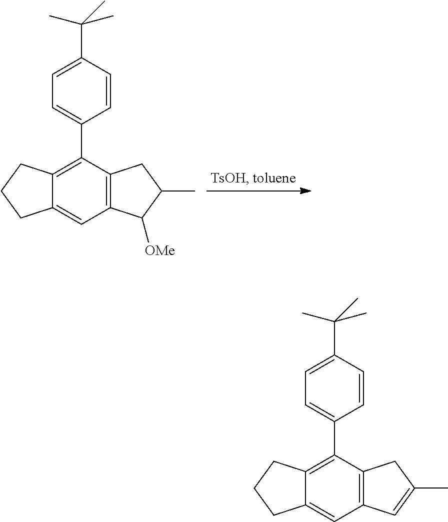

To a solution of 107 g 1-methoxy-2-methyl-4-(4-tert-butylphenyl)-1,2,3,5,6,7-hexahydro-s-indacene (prepared above) in 700 ml of toluene, 600 mg of TsOH was added, and the resulting solution was refluxed using Dean-Stark head for 10 min. After cooling to room temperature the reaction mixture was washed with 200 ml of 10% NaHCO₃. The organic layer was separated, and the aqueous layer was additionally extracted with 2×100 ml of dichloromethane. The combined organic extract was evaporated to dryness to give a red oil. The product was purified by flash-chromatography on silica gel 60 (40-63 μm; eluent: hexanes, then hexanes-dichloromethane=5:1, vol.) followed by vacuum distillation, b.p. 210-216° C./5-6 mm Hg. This procedure gave 77.1 g (80%) of 4-(4-tert-butylphenyl)-6-methyl-1,2,3,5-tetrahydro-s-indacene as a yellowish glassy material.

Anal. calc. for C₂₃H₂₆: C, 91.34; H, 8.66. Found: C, 91.47; H, 8.50.

¹H NMR (CDCl₃): δ 7.44-7.37 (m, 2H), 7.33-7.26 (m, 2H), 7.10 (s, 1H), 6.45 (br.s, 1H), 3.17 (s, 2H), 2.95 (t, J=7.3 Hz, 2H), 2.78 (t, J=7.3 Hz, 2H), 2.07 (s, 3H), 2.02 (quin, J=7.3 Hz, 2H), 1.37 (s, 9H). ¹³C{¹H} NMR (CDCl₃): δ 149.37, 145.54, 144.79, 142.91, 139.92, 138.05, 137.15, 134.06, 128.36, 127.02, 124.96, 114.84, 42.11, 34.53, 33.25, 32.16, 31.41, 25.96, 16.77.

### Bis[2-methyl-4-(4-tert-butylphenyl)-5-methoxy-6-tert-butyl-1H-inden-1-yl]dimethylsilane

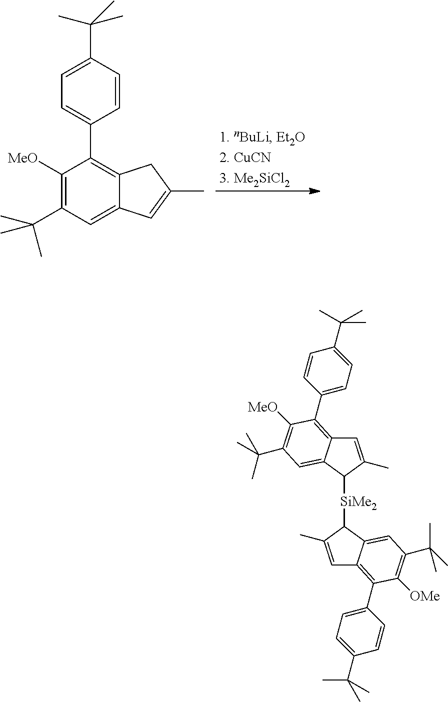

20.6 ml (50.06 mmol) of 2.43 M nBuLi in hexanes was added in one portion to a solution of 17.43 g (50.01 mmol) of 2-methyl-5-tert-butyl-7-(4-tert-butylphenyl)-6-methoxy-1H-indene in 300 ml of ether at −50° C. This mixture was stirred overnight at room temperature, then the resulting yellow solution with a lot of yellow precipitate was cooled to −60° C., and 225 mg of CuCN was added. The obtained mixture was stirred for 30 min at −25° C., and then 3.23 g (25.03 mmol) of dichlorodimethylsilane was added in one portion. Further on, this mixture was stirred overnight at ambient temperature. This solution was filtered through a pad of silica gel 60 (40-63 μm) which was additionally washed with 2×50 ml of dichloromethane. The combined filtrate was evaporated under reduced pressure, and the residue was dried in vacuum at elevated temperature. This procedure gave 18.76 g (ca. 100%, purity ca. 85%) of bis[2-methyl-4-(4-tert-butylphenyl)-5-methoxy-6-tert-butyl-1H-inden-1-yl]dimethylsilane (a ca. 7:3 mixture of diastereoisomers) as a white powder.

1H NMR (CDCl3): δ 7.50-7.39 (m, 4H), 7.32 and 7.25 (2s, sum 1H), 6.48 and 6.46 (2s, sum 1H), 3.61 and 3.58 (2s, sum 1H), 3.21 (s, 3H), 2.12 and 2.06 (2s, sum 3H), 1.43, 1.42, 1.39 and 1.38 (4s, sum 18H), −0.18 and −0.19 (2s, sum 3H). 13C{1H} NMR (CDCl3): δ 155.50, 149.45, 147.55, 147.20, 143.70, 139.37, 137.09, 135.22, 135.19, 129.74, 127.26, 126.01, 125.94, 125.04, 120.58, 120.36, 60.48, 47.42, 47.16, 35.15, 34.56, 31.47, 31.27, 31.20, 17.75, −4.92, −5.22, −5.32.

### Rac-dimethylsilanediyl-bis[2-methyl-4-(4-tert-butylphenyl)-5-methoxy-6-tert-butyl-inden-1-yl]zirconium dichloride (MC-2)

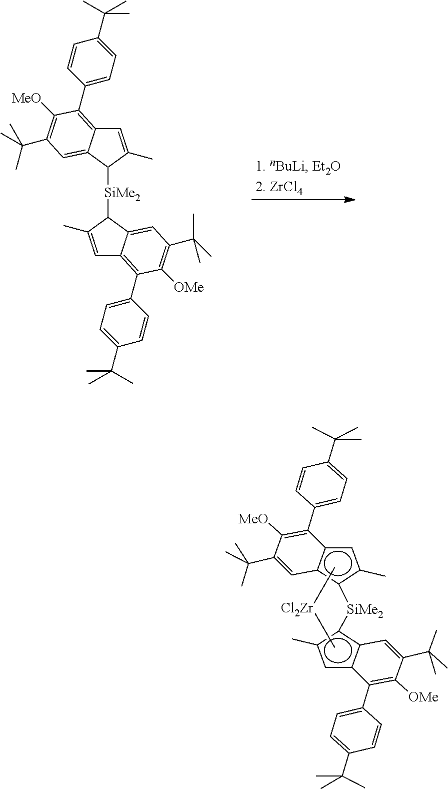

19.0 ml (46.17 mmol) of 2.43 M nBuLi in hexanes was added in one portion to a solution of 17.3 g (22.97 mmol) of bis[2-methyl-4-(4-tert-butylphenyl)-5-methoxy-6-tert-butyl-1H-inden-1-yl]dimethylsilane in 320 ml of ether cooled to −60° C. This mixture was stirred overnight at room temperature, then the resulting yellow solution with a lot of yellow precipitate was cooled to −60° C., and 5.36 g (23.0 mmol) of ZrCl4 was added. The reaction mixture was stirred for 24 h at room temperature to give orange solution with a large amount of orange precipitate. This precipitate was filtered off (G4), heated with 300 ml of methylcyclohexane, and the formed suspension was filtered while hot from LiCl through glass frit (G4). Yellow powder precipitated overnight at room temperature from the filtrate was filtered off (G3) and then dried in vacuum. This procedure gave 3.98 g of rac-complex, contaminated with ca. 3% of meso-form. This mixture was dissolved in 40 ml of hot toluene, the formed solution was evaporated in vacuum to ca. 10 ml. Yellow powder precipitated at room temperature was filtered off (G3) and then dried in vacuum to give 3.41 g (16%) of pure rac-dimethylsilanediyl-bis[2-methyl-4-(4-tert-butylphenyl)-5-methoxy-6-tert-butyl-inden-1-yl]zirconium dichloride (content of meso-form <1%). The ether mother liquor was evaporated to dryness, and the residue was dissolved in 100 ml of warm toluene. This solution was filtered through glass frit (G4), and the obtained filtrate was evaporated to ca. 40 ml. Yellow powder precipitated from this solution at room temperature was immediately filtered off and dried in vacuum to give 2.6 g of a ca. 5 to 1 mixture of rac- and meso-zirconocenes (in favor to rac-). All mother liquors were combined, evaporated to a volume ca. 20 ml, and the residue was triturated with 100 ml of n-hexane. The formed orange powder was collected and dried in vacuum. This procedure gave 5.8 g of a mixture of rac- and meso-zirconocenes. Thus, the total yield of rac- and meso-zirconocenes isolated in this synthesis was 11.81 g (56%).

Rac-dimethylsilanediyl-bis[2-methyl-4-(4-tert-butylphenyl)-5-methoxy-6-tert-butyl-inden-1-yl]zirconium dichloride.

Anal. calc. for C52H66Cl2O2SiZr: C, 68.39; H, 7.28. Found: C, 68.70; H, 7.43. 1H NMR (CDCl3): δ 7.63-7.52 (m, 2H), 7.50 (s, 1H), 7.44 (d, J=8.1 Hz, 2H), 6.63 (s, 1H), 3.39 (s, 3H), 2.16 (s, 3H), 1.38 (s, 9H), 1.33 (s, 9H), 1.29 (s, 3H). 13C{1H} NMR (CDCl3): δ 160.00, 150.16, 144.25, 135.07, 133.79, 133.70, 129.25, 127.08, 125.39, 123.09, 121.32, 120.81, 81.57, 62.61, 35.78, 34.61, 31.39, 30.33, 18.37, 2.41

### Synthesis of Metallocene MC-3

### 4-Bromo-2,6-dimethylaniline

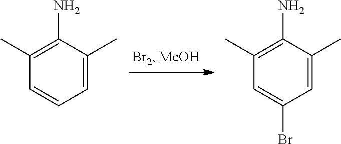

159.8 g (1.0 mol) of bromine was slowly (over 2 h) added to a stirred solution of 121.2 g (1.0 mol) of 2,6-dimethylaniline in 500 ml of methanol. The resulting dark-red solution was stirred overnight at room temperature, then poured into a cold solution of 140 g (2.5 mol) of potassium hydroxide in 1100 ml of water. The organic layer was separated, and the aqueous one was extracted with 500 ml of diethyl ether. The combined organic extract was washed with 1000 ml of water, dried over K₂CO₃, and evaporated in vacuum to give 202.1 g of 4-bromo-2,6-dimethylaniline (purity ca. 90%) as dark-red oil which crystallized upon standing at room temperature. This material was further used without additional purification.

¹H NMR (CDCl₃): δ 7.04 (s, 2H), 3.53 (br.s, 2H), 2.13 (s, 6H).

### 1-Bromo-3,5-dimethylbenzene

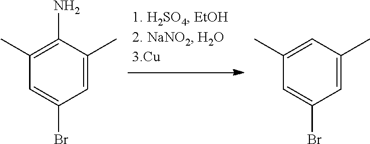

97 ml (1.82 mol) of 96% sulfuric acid was added dropwise to a solution of 134.7 g (ca. 673 mmol) of 4-bromo-2,6-dimethylaniline (prepared above, purity ca. 90%) in 1400 ml of 95% ethanol cooled to −10° C., at a such a rate to maintain the reaction temperature below 7° C. After the addition was complete, the solution was stirred at room temperature for 1 h. Then, the reaction mixture was cooled in an ice-bath, and a solution of 72.5 g (1.05 mol) of sodium nitrite in 150 ml of water was added dropwise over ca. 1 h. The formed solution was stirred at the same temperature for 30 min. Then the cooling bath was removed, and 18 g of copper powder was added. Upon completion of the rapid evolution of nitrogen additional portions (ca. 5 g each, ca.50 g in total) of copper powder were added with 10 min intervals until gas evolution ceased completely. The reaction mixture was stirred at room temperature overnight, then filtered through a glass frit (G3), diluted with two-fold volume of water, and the crude product was extracted with 4×150 ml of dichloromethane. The combined extract was dried over K₂CO₃, evaporated to dryness, and then distilled in vacuum (b.p. 60-63° C./5 mm Hg) to give a yellowish liquid. This product was additionally purified by flash-chromatography on silica gel 60 (40-63 μm; eluent: hexane) and distilled once again (b.p. 51-52° C./3 mm Hg) to give 63.5 g (51%) of 1-bromo-3,5-dimethylbenzene as a colorless liquid.

¹H NMR (CDCl₃): δ 7.12 (s, 2H), 6.89 (s, 1H), 2.27 (s, 6H). ¹³C{¹H} NMR (CDCl₃):

δ 139.81, 129.03, 128.61, 122.04, 20.99.

### (3,5-Dimethylphenyl)boronic Acid

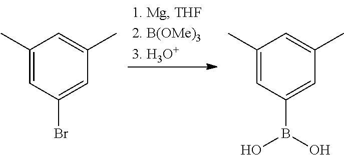

A solution of 3,5-dimethylphenylmagnesium bromide obtained from a solution of 190.3 g (1.03 mol) of 1-bromo-3,5-dimethylbenzene in 1000 ml of THF and 32 g (1.32 mol, 28% excess) of magnesium turnings was cooled to −78° C., and 104 g (1.0 mol) of trimethylborate was added in one portion. The resulting heterogeneous mixture was stirred overnight at room temperature. The boronic ester was hydrolyzed by careful addition of 1200 ml of 2 M HCl. 500 ml of diethyl ether was added, the organic layer was separated, and the aqueous layer was additionally extracted with 2×500 ml of diethyl ether. The combined organic extract was dried over Na₂SO₄ and then evaporated to dryness to give white mass. The latter was triturated with 200 ml of n-hexane, filtered through glass frit (G3), and the precipitate was dried in vacuo. This procedure gave 114.6 g (74%) of (3,5-dimethylphenyl)boronic acid.

Anal. calc. for C₈H₁₁BO₂: C, 64.06; H, 7.39. Found: C, 64.38; H, 7.72.

¹H NMR (DMSO-d₆): δ 7.38 (s, 2H), 7.00 (s, 1H), 3.44 (very br.s, 2H), 2.24 (s, 6H).

### 6-tert-Butyl-4-(3,5-dimethylphenyl)-5-methoxy-2-methylindan-1-one

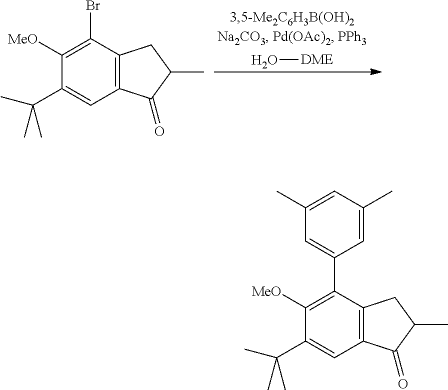

A mixture of 49.14 g (157.9 mmol) of 4-bromo-6-tert-butyl-5-methoxy-2-methylindan-1-one, 29.6 g (197.4 mmol, 1.25 eq.) of (3,5-dimethylphenyl)boronic acid, 45.2 g (427 mmol) of Na₂CO₃, 1.87 g (8.3 mmol, 5 mol. %) of Pd(OAc)₂, 4.36 g (16.6 mmol, 10 mol. %) of PPh₃, 200 ml of water, and 500 ml of 1,2-dimethoxyethane was refluxed for 6.5 h. DME was evaporated on a rotary evaporator, 600 ml of water and 700 ml of dichloromethane were added to the residue. The organic layer was separated, and the aqueous one was additionally extracted with 200 ml of dichloromethane. The combined extract was dried over K₂CO₃ and then evaporated to dryness to give a black oil. The crude product was purified by flash chromatography on silica gel 60 (40-63 μm, hexane-dichloromethane=1:1, vol., then, 1:3, vol.) to give 48.43 g (91%) of 6-tert-butyl-4-(3,5-dimethylphenyl)-5-methoxy-2-methylindan-1-one as a brownish oil.

Anal. calc. for C₂₃H₂₈O₂: C, 82.10; H, 8.39. Found: C, 82.39; H, 8.52.

¹H NMR (CDCl₃): δ 7.73 (s, 1H), 7.02 (s, 1H), 7.01 (s, 2H), 3.32 (s, 3H), 3.13 (dd, J=17.5 Hz, J=7.8 Hz, 1H), 2.68-2.57 (m, 1H), 2.44 (dd, J=17.5 Hz, J=3.9 Hz), 2.36 (s, 6H), 1.42 (s, 9H), 1.25 (d, J=7.5 Hz, 3H). ¹³C{¹H} NMR (CDCl₃): δ 208.90, 163.50, 152.90, 143.32, 138.08, 136.26, 132.68, 130.84, 129.08, 127.18, 121.30, 60.52, 42.17, 35.37, 34.34, 30.52, 21.38, 16.40.

### 5-tert-Butyl-7-(3,5-dimethylphenyl)-6-methoxy-2-methyl-1H-indene

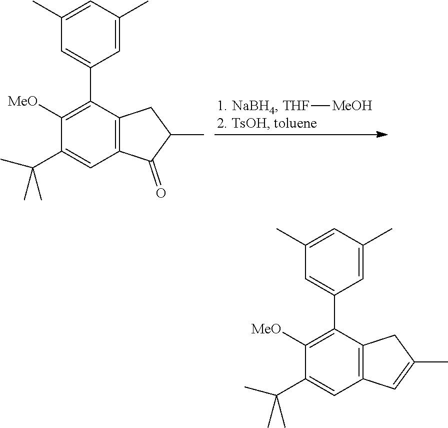

8.2 g (217 mmol) of NaBH₄ was added to a solution of 48.43 g (143.9 mmol) of 6-tert-butyl-4-(3,5-dimethylphenyl)-5-methoxy-2-methylindan-1-one in 300 ml of THF cooled to 5° C. Then, 150 ml of methanol was added dropwise to this mixture by vigorous stirring for ca. 7 h at 5° C. The resulting mixture was evaporated to dryness, and the residue was partitioned between 500 ml of dichloromethane and 500 ml of 2 M HCl. The organic layer was separated, the aqueous layer was additionally extracted with 100 ml of dichloromethane. The combined organic extract was evaporated to dryness to give a slightly yellowish oil. To a solution of this oil in 600 ml of toluene 400 mg of TsOH was added, this mixture was refluxed with Dean-Stark head for 10 min and then cooled to room temperature using a water bath. The formed solution was washed by 10% Na₂CO₃, the organic layer was separated, the aqueous layer was extracted with 150 ml of dichloromethane. The combined organic extract was dried over K₂CO₃ and then passed through a short layer of silica gel 60 (40-63 μm). The silica gel layer was additionally washed by 100 ml of dichloromethane. The combined organic elute was evaporated to dryness, and the resulting oil was dried in vacuum at elevated temperature. This procedure gave 45.34 g (98%) of 5-tert-butyl-7-(3,5-dimethylphenyl)-6-methoxy-2-methyl-1H-indene which was further used without additional purification.

Anal. calc. for C₂₃H₂₈O: C, 86.20; H, 8.81. Found: C, 86.29; H, 9.07.

¹H NMR (CDCl₃): δ 7.20 (s, 1H), 7.08 (br.s, 2H), 6.98 (br.s, 1H), 6.42 (m, 1H), 3.25 (s, 3H), 3.11 (s, 2H), 2.36 (s, 6H), 2.06 (s, 3H), 1.43 (s, 9H). ¹³C{¹H} NMR (CDCl₃): δ 154.20, 145.22, 141.78, 140.82, 140.64, 138.30, 137.64, 131.80, 128.44, 127.18, 126.85, 116.98, 60.65, 42.80, 35.12, 31.01, 21.41, 16.65.

### Bis[6-tert-butyl-4-(3,5-dimethylphenyl)-5-methoxy-2-methyl-1H-inden-1-yl]dimethylsilane

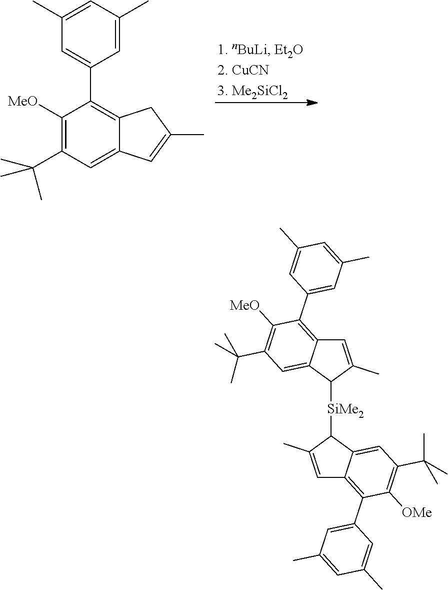

28.0 ml (70 mmol) of 2.5 M ⁿBuLi in hexanes was added in one portion to a solution of 22.36 g (69.77 mmol) of 5-tert-butyl-7-(3,5-dimethylphenyl)-6-methoxy-2-methyl-1H-indene in 350 ml of ether at −50° C. This mixture was stirred overnight at room temperature, then the resulting orange solution with a large amount of yellow precipitate was cooled to −60° C. (at this temperature the precipitate almost completely disappeared), and 400 mg of CuCN was added. The resulting mixture was stirred for 30 min at −25° C., and then 4.51 g (34.95 mmol) of dichlorodimethylsilane was added in one portion. This mixture was stirred overnight at room temperature, then filtered through a pad of silica gel 60 (40-63 μm) which was additionally washed by 2×50 ml of dichloromethane. The combined filtrate was evaporated under reduced pressure, and the residue was dried in vacuum at elevated temperature. This procedure gave 24.1 g (99%) of bis[6-tert-butyl-4-(3,5-dimethylphenyl)-5-methoxy-2-methyl-1H-inden-1-yl]dimethylsilane (>90% purity by NMR, approx. 3:1 mixture of stereoisomers) as a yellowish glass which was further used without additional purification.

¹H NMR (CDCl₃): δ 7.49, 7.32, 7.23, 7.11, 6.99 (5s, sum 8H), 6.44 and 6.43 (2s, sum 2H), 3.67, 3.55 (2s, sum 2H), 3.27, 3.26 (2s, sum 6H), 2.38 (s, 12H), 2.13 (s, 6H), 1.43 (s, 18H), −0.13, −0.18, −0.24 (3s, sum 6H). ¹³C{¹H} NMR (CDCl₃): δ 155.29, 147.57, 147.23, 143.63, 139.37, 139.26, 138.19, 137.51, 137.03, 128.24, 127.90, 127.47, 126.01, 125.89, 120.53, 120.34, 60.51, 47.35, 47.16, 35.14, 31.28, 31.20, 21.44, 17.94, 17.79, −4.84, −4.89, −5.84.

### Rac-dimethylsilanediyl-bis[2-methyl-4-(3,5-dimethylphenyl)-5-methoxy-6-tert-butyl-inden-1-yl]zirconium dichloride (MC-3)

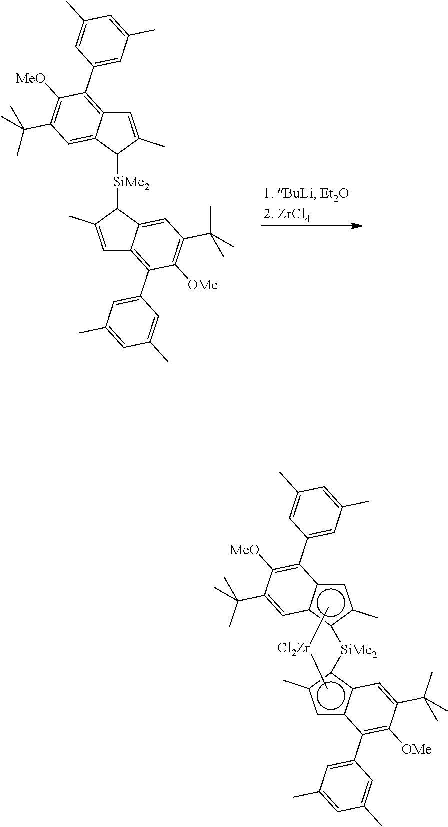

27.7 ml (69.3 mmol) of 2.5 M ⁿBuLi in hexanes was added in one portion to a solution of 24.1 g (34.53 mmol) of bis[6-tert-butyl-4-(3,5-dimethylphenyl)-5-methoxy-2-methyl-1H-inden-1-yl]dimethylsilane (prepared above) in 350 ml of diethyl ether cooled to −50° C. This mixture was stirred overnight at room temperature, then the resulting yellow solution with a large amount of yellow precipitate was cooled to −50° C., and 8.05 g (34.54 mmol) of ZrCl₄ was added. The reaction mixture was stirred for 24 h at room temperature to give a reddish-orange solution containing some precipitate. This mixture was evaporated to dryness. The residue was heated with 200 ml of toluene, and the formed suspension was filtered while hot through a glass frit (G4). The filtrate was evaporated to 70 ml, and then 50 ml of hexane was added. Crystals precipitated from this solution overnight at room temperature were collected, washed with 25 ml of hexane, and dried in vacuo. This procedure gave 4.01 g of pure rac-zirconocene. The mother liquor was evaporated to ca. 50 ml, and 50 ml of hexane was added. Orange crystals precipitated from this solution overnight at room temperature were collected and then dried in vacuum. This procedure gave 2.98 g of rac-zirconocene. Again, the mother liquor was evaporated almost to dryness, and 50 ml of hexane was added. Orange crystals precipitated from this solution overnight at −30° C. were collected and dried in vacuum. This procedure gave 3.14 g of rac-zirconocene. Thus, the total yield of rac-zirconocene isolated in this synthesis was 10.13 g (34%).

### Rac-MC-3

Anal. calc. for C₄₈H₅₈Cl₂O₂SiZr: C, 67.26; H, 6.82. Found: C, 67.42; H, 6.99.

¹H NMR (CDCl₃): δ 7.49 (s, 1H), 7.23 (very br.s, 2H), 6.96 (s, 1H), 6.57 (s, 1H), 3.44 (s, 3H), 2.35 (s, 6H), 2.15 (s, 3H), 1.38 (s, 9H), 1.27 (s, 3H). ¹³C{¹H} NMR (CDCl₃): δ 159.78, 144.04, 137.87, 136.85, 134.89, 133.86, 128.85, 127.39, 127.05, 122.91, 121.18, 120.80, 81.85, 62.66, 35.76, 30.38, 21.48, 18.35, 2.41.

Synthesis of metallocene MC-4:

### 4-(4-tert-Butylphenyl)-6-methyl-1,2,3,5-tetrahydro-s-indacene

The precursor 4-(4-tert-Butylphenyl)-6-methyl-1,2,3,5-tetrahydro-s-indacene was made according to the procedure described above for metallocene MC-2.

### 2-methyl-[4-(4-tert-butylphenyl)-1,5,6,7-tetrahydro-s-indacen-1-yl](chloro)dimethylsilane

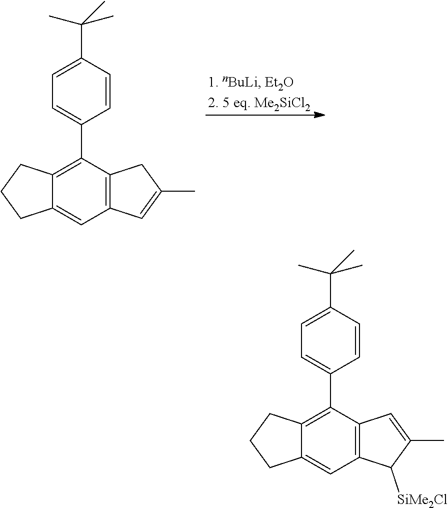

To a solution of 22.3 g (73.73 mmol) of 4-(4-tert-butylphenyl)-6-methyl-1,2,3,5-tetrahydro-s-indacene in 300 ml of ether, cooled to −50° C., 30.4 ml (73.87 mmol) of 2.43 M ⁿBuLi in hexanes was added in one portion. The resulting mixture was stirred overnight at room temperature, then the resulting suspension with a large amount of precipitate was cooled to −78° C. (wherein the precipitate was substantially dissolved to form an orange solution), and 47.6 g (369 mmol, 5 equiv.) of dichlorodimethylsilane was added in one portion. The obtained solution was stirred overnight at room temperature and then filtered through a glass frit (G4). The filtrate was evaporated to dryness to give 28.49 g (98%) of 2-methyl-[4-(4-tert-butylphenyl)-1,5,6,7-tetrahydro-s-indacen-1-yl](chloro) dimethylsilane as a colorless glass which was used without further purification.

¹H NMR (CDCl₃): δ 7-50-7.45 (m, 2H), 7.36 (s, 1H), 7.35-7.32 (m, 2H), 6.60 (s, 1H), 3.60 (s, 1H), 3.10-2.82 (m, 4H), 2.24 (s, 3H), 2.08 (quin, J=7.3 Hz, 2H), 1.42 (s, 9H), 0.48 (s, 3H), 0.22 (s, 3H). ¹³C{¹H} NMR (CDCl₃): δ 149.27, 144.41, 142.15, 141.41, 139.94, 139.83, 136.85, 130.19, 129.07, 126.88, 124.86, 118.67, 49.76, 34.55, 33.27, 32.32, 31.44, 26.00, 17.6

### 2-methyl-4-(4-tert-butylphenyl)-5-methoxy-6-tert-butyl-indan-1-one

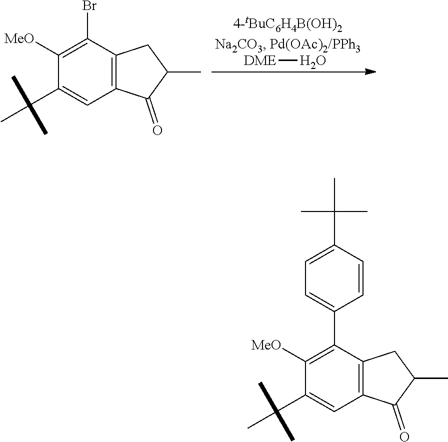

A mixture of 31.1 g (100 mmol) of 2-methyl-4-bromo-5-methoxy-6-tert-butyl-indan-1-one, 25.0 g (140 mmol) of 4-tert-butylphenylboronic acid, 29.4 g (280 mmol) of Na₂CO₃, 1.35 g (6.00 mmol, 6 mol. %) of Pd(OAc)₂, and 3.15 g (12.0 mmol, 12 mol. %) of PPh₃ in 130 ml of water and 380 ml of DME was refluxed for 6 h in argon atmosphere. The formed mixture was evaporated to dryness. To the residue 500 ml of dichloromethane and 500 ml of water were added. The organic layer was separated, the aqueous layer was additionally extracted with 100 ml of dichloromethane. The combined organic extract was dried over Na₂SO₄, evaporated to dryness, and the crude product was isolated using flash chromatography on silica gel 60 (40-63 μm; eluent: hexanes-dichloromethane=2:1, vol.). This crude product was recrystallized from n-hexane to give 29.1 g (81%) of a white solid.

Anal. calc. for C₂₅H₃₂O₂: C, 82.37; H, 8.85. Found: C, 82.26; H, 8.81.

¹H NMR (CDCl₃): δ 7.74 (s, 1H, 7-H in indenyl), 7.48 (d, J=8.0 Hz, 2H, 2,6-H in C₆H₄^{t}Bu), 7.33 (d, J=8.0 Hz, 2H, 3,5-H in C₆H₄^{t}Bu), 3.27 (s, 3H, OMe), 3.15 (dd, J=17.3 Hz, J=7.7 Hz, 1H, 3-H in indan-1-on), 2.67-2.59 (m, 1H, 2-H in indan-1-on), 2.48 (dd, J=17.3 Hz, J=3.7 Hz, 3′-H in indan-1-on), 1.42 (s, 9H, ^{t}Bu in C₆H₄^{t}Bu), 1.38 (s, 9H, 6-^{t}Bu in indan-1-on), 1.25 (d, J=7.3 Hz, 3H, 2-Me in indan-1-one).

### 2-methyl-5-tert-butyl-6-methoxy-7-(4-tert-butylphenyl)-1H-indene

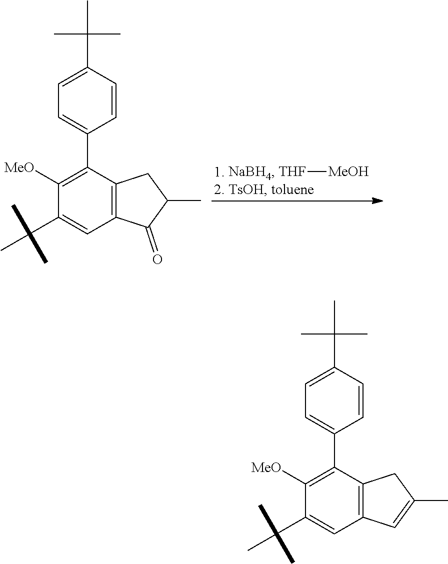

To a solution of 28.9 g (79.2 mmol) of 2-methyl-4-(4-tert-butylphenyl)-5-methoxy-6-tert-butyl-indan-1-one in 400 ml of THF cooled to 5° C. 5.00 g (132 mmol) of NaBH₄ was added. Further on, 100 ml of methanol was added dropwise to this mixture by vigorous stirring for ca. 7 h at 5° C. The resulting mixture was evaporated to dryness, and the residue wad partitioned between 500 ml of dichloromethane and 1000 ml of 0.5 M HCl. The organic layer was separated, the aqueous layer was additionally extracted with 100 ml of dichloromethane. The combined organic extract was evaporated to dryness to give a colorless oil. To a solution of this oil in 500 ml of toluene 1.0 g of TsOH was added. The formed mixture was refluxed with Dean-Stark head for 15 min and then cooled to room temperature using water bath. The resulting reddish solution was washed by 10% aqueous Na₂CO₃, the organic layer was separated, the aqueous layer was extracted with 2×100 ml of dichloromethane. The combined organic extract was dried over K₂CO₃ and then passed through short pad of silica gel 60 (40-63 μm). The silica gel pad was additionally washed with 50 ml of dichloromethane. The combined organic elute was evaporated to dryness to give a yellowish crystalline mass. The product was isolated by re-crystallization of this mass from 150 ml of hot n-hexane. Crystals precipitated at 5° C. were collected dried in vacuum. This procedure gave 23.8 g of white macrocrystalline 2-methyl-5-tert-butyl-6-methoxy-7-(4-tert-butylphenyl)-1H-indene. The mother liquor was evaporated to dryness and the residue was recrystallized from 20 ml of hot n-hexane in the same way. This procedure gave additional 2.28 g of the product. Thus, the total yield of the title product was 26.1 g (95%).

Anal. calc. for C₂₅H₃₂O: C, 86.15; H, 9.25. Found: C, 86.24; H, 9.40.

¹H NMR (CDCl₃): δ 7.44 (d, J=8.5 Hz, 2H, 2,6-H in C₆H₄^{t}Bu), 7.40 (d, J=8.5 Hz, 2H, 3,5-H in C₆H₄^{t}Bu), 7.21 (s, 1H, 4-H in indenyl), 6.43 (m, 1H, 3-H in indenyl), 3.20 (s, 3H, OMe), 3.15 (s, 2H, 1-H in indenyl), 2.05 (s, 3H, 2-Me in indenyl), 1.43 (s, 9H, 5-′Bu in indenyl), 1.37 (s, 9H, ^{t}Bu in C₆H₄^{t}Bu).

### [2-methyl-4-(4-tert-butylphenyl)-5-methoxy-6-tert-butyl-1H-inden-1-yl][2-methyl-4-(4-tert-butylphenyl)-1,5,6,7-tetrahydro-s-indacen-1-yl]dimethylsilane

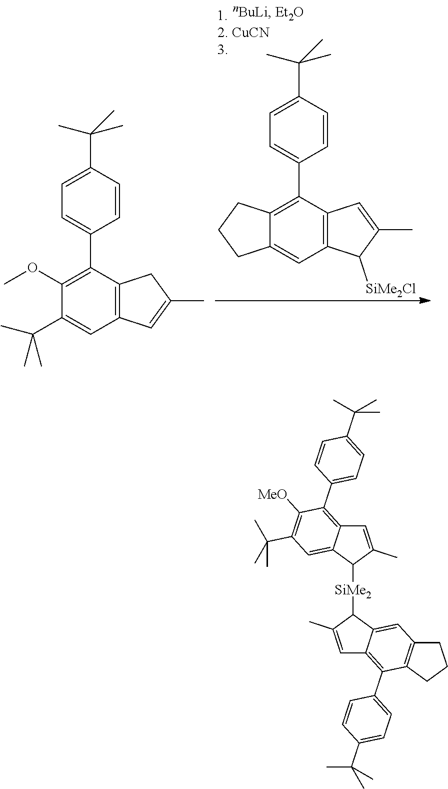

To a solution of 8.38 g (24.04 mmol) of 2-methyl-5-tert-butyl-7-(4-tert-butylphenyl)-6-methoxy-1H-indene in 150 ml of ether 9.9 ml (24.06 mmol) of 2.43 M ⁿBuLi in hexanes was added in one portion at −50° C. This mixture was stirred overnight at room temperature, then the resulting yellow solution with yellow precipitate was cooled to −50° C., and 150 mg of CuCN was added. The obtained mixture was stirred for 0.5 h at −25° C., then a solution of 9.5 g (24.05 mmol) of 2-methyl-[4-(4-tert-butylphenyl)-1,5,6,7-tetrahydro-s-indacen-1-yl](chloro)dimethylsilane in 150 ml of ether was added in one portion. This mixture was stirred overnight at room temperature, then filtered through a pad of silica gel 60 (40-63 μm), which was additionally washed by 2×50 ml of dichloromethane. The combined filtrate was evaporated under reduced pressure, and the residue was dried in vacuum at elevated temperature. This procedure gave 17.2 g (ca. 100%) of [2-methyl-4-(4-tert-butylphenyl)-5-methoxy-6-tert-butyl-1H-inden-1-yl][2-methyl-4-(4-tert-butylphenyl)-1,5,6,7-tetrahydro-s-indacen-1-yl]dimethylsilane (ca. 95% purity by NMR spectroscopy, approx. 1:1 mixture of stereoisomers) as yellowish glassy solid which was used in the next step without additional purification.

¹H NMR (CDCl₃): δ 7.50 (s, 0.5H), 7.48-7.41 (m, 6H), 7.37-7.33 (m, 2.5H), 7.26 (s, 0.5H), 7.22 (s, 0.5H), 6.57 and 6.50 (2s, sum 2H), 3.71, 3.69, 3.67 and 3.65 (4s, sum 2H), 3.23 and 3.22 (2s, sum 3H), 3.03-2.80 (m, 4H), 2.20, 2.16 and 2.14 (3s, sum 6H), 2.08-1.99 (m, 2H), 1.43 and 1.41 (2s, sum 9H), 1.39 (s, 18H), −0.19, −0.20, −0.21 and −0.23 (4s, sum 6H). ¹³C{¹H} NMR (CDCl₃): δ 155.49, 155.46, 149.41, 149.14, 149.11, 147.48, 147.44, 146.01, 145.77, 143.95, 143.91, 143.76, 143.71, 142.14, 142.10, 139.52, 139.42, 139.34, 139.29, 139.20, 139.16, 137.10, 137.05, 137.03, 135.20, 130.05, 130.03, 129.73, 129.11, 127.25, 127.22, 126.20, 126.13, 125.98, 125.94, 125.05, 124.82, 120.59, 120.52, 118.51, 118.26, 60.51, 60.48, 47.31, 46.89, 46.72, 35.14, 34.55, 33.34, 33.28, 32.30, 31.47, 31.45, 31.24, 31.19, 26.02, 25.99, 17.95, 17.86.

### Anti-dimethylsilanediyl[2-methyl-4-(4-tert-butylphenyl)-5-methoxy-6-tert-butylinden-1-yl][2-methyl-4-(4-tert-butylphenyl)-1,5,6,7-tetrahydro-s-indacen-1-yl]zirconium dichloride

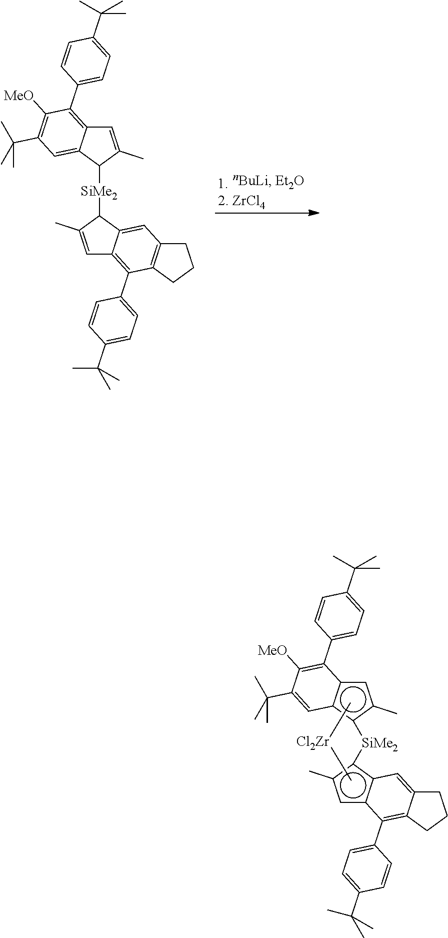

To a solution of 17.2 g (ca. 24.04 mol) of [2-methyl-4-(4-tert-butylphenyl)-5-methoxy-6-tert-butyl-1H-inden-1-yl][2-methyl-4-(4-tert-butylphenyl)-1,5,6,7-tetrahydro-s-indacen-1-yl]dimethylsilane (prepared above) in 250 ml of ether, cooled to −50° C., 19.8 ml (48.11 mmol) of 2.43 M ⁿBuLi in hexanes was added in one portion. This mixture was stirred for 4 h at room temperature, then the resulting cherry-red solution was cooled to −60° C., and 5.7 g (24.46 mmol) of ZrCl₄ was added. The reaction mixture was stirred for 24 h at room temperature to give red solution with orange precipitate. This mixture was evaporated to dryness. The residue was heated with 200 ml of toluene, and the formed suspension was filtered through glass frit (G4). The filtrate was evaporated to 90 ml. Yellow powder precipitated from this solution overnight at room temperature was collected, washed with 10 ml of cold toluene, and dried in vacuum. This procedure gave 4.6 g (22%) of a ca. 4 to 1 mixture of anti- and syn-zirconocenes. The mother liquor was evaporated to ca. 40 ml, and 20 ml of n-hexane was added. Orange powder precipitated from this solution overnight at room temperature was collected and dried in vacuum. This procedure gave 6.2 g (30%) of a ca. 1 to 1 mixture of anti- and syn-zirconocenes. Thus, the total yield of anti- and syn-zirconocenes isolated in this synthesis was 10.8 g (52%). Pure anti-zirconocene was obtained after crystallization of the above-described 4.6 g sample of a ca. 4 to 1 mixture of anti- and syn-zirconocenes from 20 ml of toluene. This procedure gave 1.2 g of pure anti-zirconocene. Anti-dimethylsilanediyl[2-methyl-4-(4-tert-butylphenyl)-5-methoxy-6-tert-butylinden-1-yl][2-methyl-4-(4-tert-butylphenyl)-1,5,6,7-tetrahydro-s-indacen-1-yl]zirconium dichloride:

Anal. calc. for C₅₀H₆₀Cl₂OSiZr: C, 69.25; H, 6.97. Found: C, 69.43; H, 7.15.

¹H NMR (CDCl₃): δ 7.59-7.38 (group of m, 10H), 6.74 (s, 1H), 6.61 (s, 1H), 3.37 (s, 3H), 3.08-2.90 (m, 3H), 2.86-2.78 (m, 1H), 2.20 (s, 3H), 2.19 (s, 3H), 2.10-1.92 (m, 2H), 1.38 (s, 9H), 1.33 (s, 18H), 1.30 (s, 3H), 1.29 (s, 3H). ¹³C{¹H} NMR (CDCl₃,): δ 159.94, 150.05, 149.86, 144.79, 144.01, 143.20, 135.50, 135.41, 133.87, 133.73, 133.62, 132.82, 132.29, 129.23, 128.74, 126.95, 126.87, 125.36, 125.12, 122.93, 121.68, 121.32, 120.84, 117.90, 81.65, 81.11, 62.57, 35.74, 34.58, 33.23, 32.17, 31.37, 31.36, 30.32, 26.60, 18.39, 18.30, 2.65, 2.57¹. ¹Resonance originated from one carbon atom was not found because of overlapping with some other signal.

### Synthesis of MC-5

### 2-methyl-5-tert-butyl-6-methoxy-7-(3,5-dimethylphenyl)-1H-indene

The precursor 2-methyl-5-tert-butyl-6-methoxy-7-(3,5-dimethylphenyl)-1H-indene was made according to the procedure described above for metallocene MC-3.

### [2-methyl-4-(3,5-dimethylphenyl)-5-methoxy-6-tert-butyl-1H-inden-1-yl][2-methyl-4-(4-tert-butylphenyl)-1,5,6,7-tetrahydro-s-indacen-1-yl]dimethylsilane

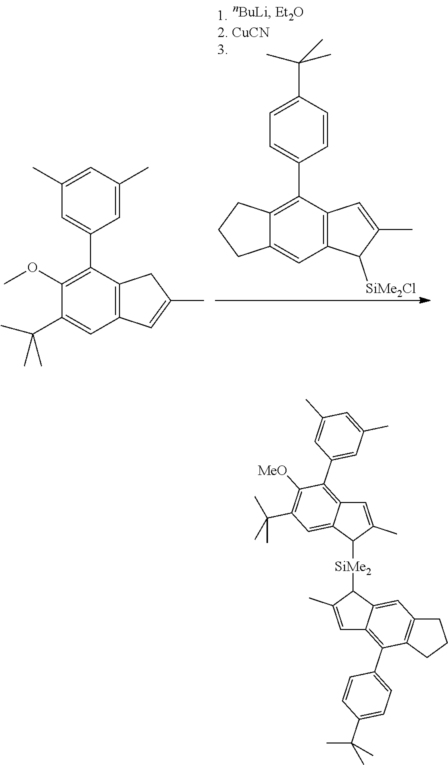

To a solution of 7.87 g (24.56 mmol) of 2-methyl-5-tert-butyl-6-methoxy-7-(3,5-dimethylphenyl)-1H-indene in 150 ml of ether, 10.1 ml (24.54 mmol) of 2.43 M ⁿBuLi in hexanes was added in one portion at −50° C. This mixture was stirred overnight at room temperature, then the resulting yellow solution with a large amount of yellow precipitate was cooled to −50° C. (wherein the precipitate disappeared completely), and 150 mg of CuCN was added. The obtained mixture was stirred for 0.5 h at −25° C., then a solution of 9.70 g (24.55 mmol) of 2-methyl-[4-(4-tert-butylphenyl)-1,5,6,7-tetrahydro-s-indacen-1-yl](chloro)dimethylsilane (as prepared above) in 150 ml of ether was added in one portion. This mixture was stirred overnight at room temperature, then filtered through a pad of silica gel 60 (40-63 μm), which was additionally washed with 2×50 ml of dichloromethane. The combined filtrate was evaporated under reduced pressure, and the residue was dried in vacuum at elevated temperature. This procedure gave 16.2 g (97%) of [2-methyl-4-(3,5-dimethylphenyl)-5-methoxy-6-tert-butyl-1H-inden-1-yl][2-methyl-4-(4-tert-butylphenyl)-1,5,6,7-tetrahydro-s-indacen-1-yl]dimethylsilane (>95% purity by NMR, approx. 1:1 mixture of the stereoisomers) as a yellowish glassy solid which was further used without an additional purification.

¹H NMR (CDCl₃): δ 7.49 (s, 0.5H), 7.47-7.42 (m, 2H), 7.37-7.32 (m, 2.5H), 7.25 (s, 0.5H), 7.22 (s, 0.5H), 7.15-7.09 (m, 2H), 7.01-6.97 (m, 1H), 6.57, 6.56 and 6.45 (3s, sum 2H), 3.70, 3.69, 3.67 and 3.65 (4s, sum 2H), 3.28 and 3.27 (2s, sum 3H), 3.01-2.79 (m, 4H), 2.38 (s, 6H), 2.19, 2.16 and 2.13 (3s, sum 6H), 2.07-2.00 (m, 2H), 1.43 and 1.41 (2s, sum 9H), 1.38 (s, 9H), −0.18, −0.19, −0.20 and −0.23 (4s, sum 6H). ¹³C{¹H} NMR (CDCl₃): δ 155.30, 155.27, 149.14, 149.10, 147.45, 147.38, 146.01, 145.77, 143.98, 143.92, 143.73, 143.68, 142.13, 142.09, 139.51, 139.41, 139.26, 139.23, 139.19, 139.15, 138.22, 137.51, 137.08, 137.05, 136.98, 130.05, 130.01, 129.11, 128.22, 127.90, 127.48, 127.44, 126.18, 126.13, 125.97, 125.92, 124.82, 120.55, 120.49, 118.50, 118.27, 60.54, 60.50, 47.34, 47.33, 46.87, 46.72, 35.14, 34.54, 33.34, 33.28, 32.30, 31.44, 31.25, 31.20, 26.02, 26.01, 21.45, 17.95, 17.87.

### Anti-dimethylsilanediyl[2-methyl-4-(3,5-dimethylphenyl)-5-methoxy-6-tert-butylinden-1-yl][2-methyl-4-(4-tert-butylphenyl)-1,5,6,7-tetrahydro-s-indacen-1-yl]zirconium Dichloride

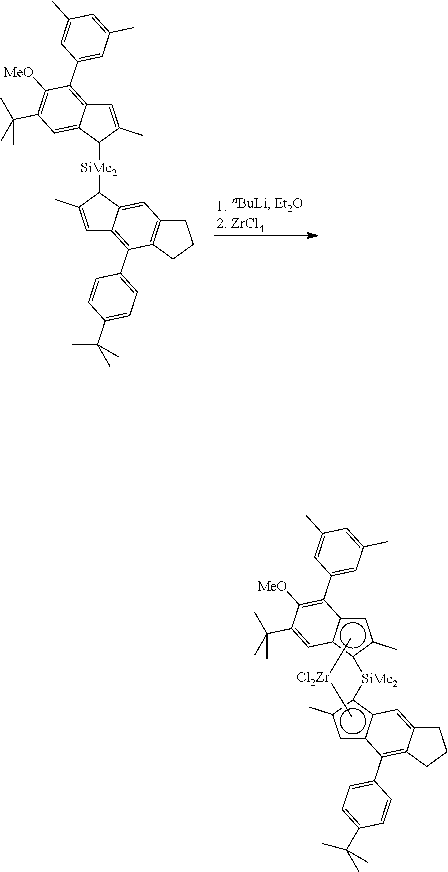

To a solution of 16.2 g (23.86 mmol) of [2-methyl-4-(3,5-dimethylphenyl)-5-methoxy-6-tert-butyl-1H-inden-1-yl][2-methyl-4-(4-tert-butylphenyl)-1,5,6,7-tetrahydro-s-indacen-1-yl]dimethylsilane (prepared above) in 250 ml of ether, cooled to −50° C., 19.7 ml (47.87 mmol) of 2.43 M ⁿBuLi in hexanes was added in one portion. This mixture was stirred for 4 h at room temperature, then the resulting red solution was cooled to −50° C., and 5.57 g (23.9 mmol) of ZrCl₄ was added. The reaction mixture was stirred for 24 h at room temperature to give red solution with orange precipitate. This mixture was evaporated to dryness. The residue was treated with 150 ml of hot toluene, and the formed suspension was filtered through glass frit (G4). The filtrate was evaporated to 50 ml, and then 20 ml of n-hexane was added. The orange crystals precipitated from this solution overnight at room temperature were collected, washed with 10 ml of cold toluene, and dried in vacuum. This procedure gave 5.02 g (25%) of anti-zirconocene as a solvate with toluene (×0.75 toluene). The mother liquor was evaporated to ca. 30 ml, and 30 ml of n-hexane was added. The orange powder precipitated from this solution overnight at room temperature was collected and dried in vacuum. This procedure gave 6.89 g (34%) of a ca. 3 to 7 mixture of anti- and syn-zirconocenes. Thus, the total yield of rac-zirconocene isolated in this synthesis was 11.91 g (60%).

### Anti-dimethylsilanediyl[2-methyl-4-(3,5-dimethylphenyl)-5-methoxy-6-tert-butylinden-1-yl][2-methyl-4-(4-tert-butylphenyl)-1,5,6,7-tetrahydro-s-indacen-1-yl]zirconium Dichloride

Anal. calc. for C₄₈H₅₆Cl₂OsiZr×0.75C₇H₈: C, 70.42; H, 6.88. Found: C, 70.51; H, 6.99.

¹H NMR (CDCl₃): δ 7.63-7.03 (very br.s, 2H), 7.59-7.51 (br.m, 2H), 7.51-7.42 (m, 4H), 6.98 (s, 1H), 6.78 (s, 1H), 6.60 (s, 1H), 3.46 (s, 3H), 3.11-3.04 (m, 1H), 3.04-2.93 (m, 2H), 2.88-2.81 (m, 1H), 2.36 (s, 6H), 2.22 (s, 3H), 2.21 (s, 3H), 2.12-1.94 (m, 2H), 1.41 (s, 9H), 1.36 (s, 9H), 1.32 (s, 3H), 1.31 (s, 3H). ¹³C{¹H} NMR

(CDCl₃,): δ 159.78, 149.90, 144.67, 144.07, 143.07, 136.75, 135.44, 135.40, 133.97, 133.51, 132.90, 132.23, 128.84, 128.76, 127.34, 127.01, 126.73, 125.28, 125.17, 122.89, 121.68, 121.59, 120.84, 117.94, 81.60, 81.26, 62.61, 35.73, 34.60, 33.20, 32.17, 31.36, 30.34, 26.56, 21.40, 18.41, 18.26, 2.65, 2.54.

### Synthesis of MC-6

### 2-methyl-5-tert-butyl-6-methoxy-7-(3,5-dimethylphenyl)-1H-indene

The precursor 2-methyl-5-tert-butyl-6-methoxy-7-(3,5-dimethylphenyl)-1H-indene was made according to the procedure described above for metallocene MC-3.

### [2-methyl-4-(3,5-dimethylphenyl)-5-methoxy-6-tert-Butyl-1H-inden-1-yl](chloro)dimethylsilane

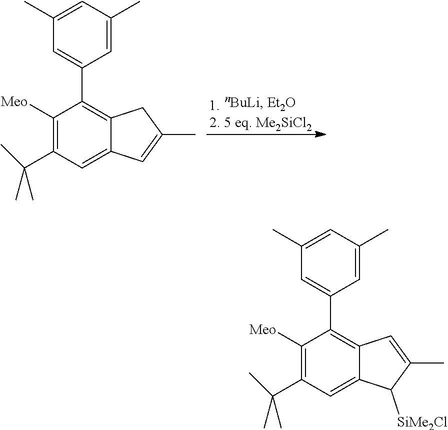

To a solution of 9.0 g (28.08 mmol) of 2-methyl-5-tert-butyl-6-methoxy-7-(3,5-dimethylphenyl)-1H-indene in 150 ml of ether, cooled to −50° C., 11.6 ml (28.19 mmol) of 2.43 M ⁿBuLi in hexanes was added in one portion. The resulting mixture was stirred for 6 h at room temperature, then the obtained yellow suspension was cooled to −60° C., and 18.1 g (140.3 mmol, 5 equiv.) of dichlorodimethylsilane was added in one portion. The obtained solution was stirred overnight at room temperature and then filtered through a glass frit (G3). The filtrate was evaporated to dryness to give [2-methyl-4-(3,5-dimethylphenyl)-5-methoxy-6-tert-Butyl-1H-inden-1-yl](chloro)dimethylsilane as a slightly yellowish oil which was further used without an additional purification.

¹H NMR (CDCl₃): δ 7.38 (s, 1H), 7.08 (s, 2H), 6.98 (s, 1H), 6.43 (s, 1H), 3.53 (s, 1H), 3.25 (s, 3H), 2.37 (s, 6H), 2.19 (s, 3H), 1.43 (s, 9H), 0.43 (s, 3H), 0.17 (s, 3H). ¹³C{¹H} NMR (CDCl₃): δ 155.78, 145.88, 143.73, 137.98, 137.56, 137.49, 136.74, 128.32, 127.86, 127.55, 126.64, 120.86, 60.46, 49.99, 35.15, 31.16, 21.41, 17.55, 1.11, −0.58.

### 1-methoxy-2-methyl-4-(3,5-Dimethylphenyl)-1,2,3,5,6,7-hexahydro-s-indacene

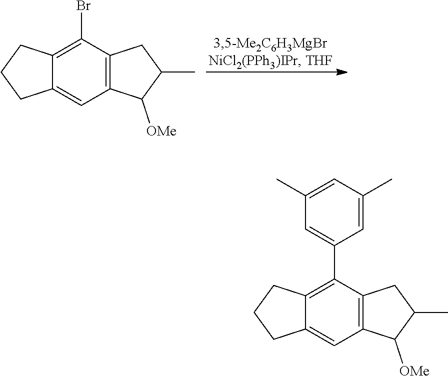 [SMILES: COC1c2cc3c(c(Br)c2CC1C)CCC3 ; COC1c2cc3c(c(-c4cc(C)cc(C)c4)c2CC1C)CCC3]

To a mixture of 2.0 g (2.56 mmol, 1.8 mol. %) of NiCl₂(PPh₃)IPr and 40.0 g (142.3 mmol) of 4-bromo-1-methoxy-2-methyl-1,2,3,5,6,7-hexahydro-s-indacene, 200 ml (200 mmol, 1.4 eq) of 3,5-dimethylphenylmagnesium bromide 1.0 M in THF was added. The resulting solution was refluxed for 3 h, then cooled to room temperature, and 400 ml of water followed by 500 ml of 1.0 M HCl solution were added. Further on, this mixture was extracted with 600 ml of dichloromethane, the organic layer was separated, and the aqueous layer was extracted with 2×100 ml of dichloromethane. The combined organic extract was evaporated to dryness to give a slightly greenish oil. The product was isolated by flash-chromatography on silica gel 60 (40-63 μm; eluent: hexanes-dichloromethane=2:1, vol., then 1:2, vol.). This procedure gave 43.02 g (99%) of 1-methoxy-2-methyl-4-(3,5-dimethylphenyl)-1,2,3,5,6,7-hexahydro-s-indacene as a colorless thick oil as a mixture of two diastereoisomers.

Anal. calc. for C₂₂H₂₆O: C, 86.23; H, 8.55. Found: C, 86.07; H, 8.82.

¹H NMR (CDCl₃), Syn-isomer: δ 7.21 (s, 1H), 6.94 (br.s, 1H), 6.90 (br.s, 2H), 4.48 (d, J=5.5 Hz, 1H), 3.43 (s, 3H), 2.94 (t, J=7.5 Hz, 2H), 2.87-2.65 (m, 3H), 2.63-2.48 (m, 2H), 2.33 (s, 6H), 2.02 (quin, J=7.5 Hz, 2H), 1.07 (d, J=6.7 Hz, 3H); Anti-isomer: δ 7.22 (s, 1H), 6.94 (br.s, 1H), 6.89 (br.s, 2H), 4.38 (d, J=4.0 Hz, 1H), 3.48 (s, 3H), 3.06 (dd, J=16.0 Hz, J=7.5 Hz, 1H), 2.93 (t, J=7.3 Hz, 2H), 2.75 (td, J=7.3 Hz, J=3.2 Hz, 2H), 2.51-2.40 (m, 1H), 2.34 (s, 6H), 2.25 (dd, J=16.0 Hz, J=5.0 Hz, 1H), 2.01 (quin, J=7.3 Hz, 2H), 1.11 (d, J=7.1 Hz, 3H). ¹³C{¹H} NMR (CDCl₃), Syn-isomer: δ 142.69, 142.49, 141.43, 139.97, 139.80, 137.40, 135.46, 128.34, 126.73, 120.09, 86.29, 56.76, 39.43, 37.59, 33.11, 32.37, 25.92, 21.41, 13.73; Anti-isomer: δ 143.11, 142.72, 140.76, 139.72, 139.16, 137.37, 135.43, 128.29, 126.60, 119.98, 91.53, 56.45, 40.06, 37.65, 33.03, 32.24, 25.88, 21.36, 19.36.

### 4-(3,5-Dimethylphenyl)-6-methyl-1,2,3,5-tetrahydro-s-indacene

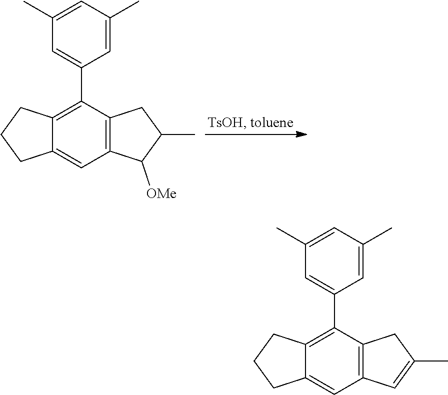

To the solution of 43.02 g (140.4 mmol) 1-methoxy-2-methyl-4-(3,5-dimethylphenyl)-1,2,3,5,6,7-hexahydro-s-indacene in 600 ml of toluene, 200 mg of TsOH was added, and the resulting solution was refluxed using Dean-Stark head for 15 min. After cooling to room temperature the reaction mixture was washed with 200 ml of 10% NaHCO₃. The organic layer was separated, and the aqueous layer was additionally extracted with 300 ml of dichloromethane. The combined organic extract was evaporated to dryness to give light orange oil. The product was isolated by flash-chromatography on silica gel 60 (40-63 μm; eluent: hexanes, then hexanes-dichloromethane=10:1, vol.). This procedure gave 35.66 g (93%) of 4-(3,5-dimethylphenyl)-6-methyl-1,2,3,5-tetrahydro-s-indacene as a slightly yellowish oil which spontaneously solidified to form a white mass.

Anal. calc. for C₂₁H₂₂: C, 91.92; H, 8.08. Found: C, 91.78; H, 8.25.

¹H NMR (CDCl₃): δ 7.09 (s, 1H), 6.98 (br.s, 2H), 6.96 (br.s, 1H), 6.44 (m, 1H), 3.14 (s, 2H), 2.95 (t, J=7.3 Hz, 2H), 2.76 (t, J=7.3 Hz, 2H), 2.35 (s, 6H), 2.07 (s, 3H), 2.02 (quin, J=7.3 Hz, 2H). ¹³C{¹H} NMR (CDCl₃): δ 145.46, 144.71, 142.81, 140.17, 139.80, 137.81, 137.50, 134.33, 128.35, 127.03, 126.48, 114.83, 42.00, 33.23, 32.00, 25.87, 21.38, 16.74.

### [2-methyl-4-(3,5-dimethylphenyl)-5-methoxy-6-tert-Butyl-1H-inden-1-yl][2-methyl-4-(3,5-dimethylphenyl)-1,5,6,7-tetrahydro-s-indacen-1-yl]dimethylsilane

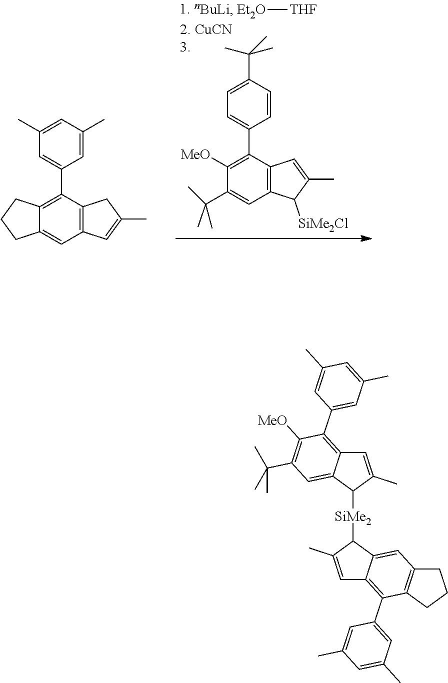

To a solution of 7.71 g (28.1 mmol) of 4-(3,5-dimethylphenyl)-6-methyl-1,2,3,5-tetrahydro-s-indacene in a mixture of 150 ml of ether and 20 ml of THF 11.6 ml (28.19 mmol) of 2.43 M ⁿBuLi in hexanes was added in one portion at −50° C. This mixture was stirred for 6 h at room temperature, then the resulting orange solution was cooled to −50° C., and 150 mg of CuCN was added. The obtained mixture was stirred for 0.5 h at −25° C., then a solution of [2-methyl-4-(3,5-dimethylphenyl)-5-methoxy-6-tert-butyl-1H-inden-1-yl](chloro)dimethylsilane (prepared above, ca. 28.08 mmol) in 150 ml of ether was added in one portion. This mixture was stirred overnight at room temperature, then filtered through a pad of silica gel 60 (40-63 μm), which was additionally washed by 2×50 ml of dichloromethane. The combined filtrate was evaporated under reduced pressure to give a yellow oil. The product was isolated by flash-chromatography on silica gel 60 (40-63 μm; eluent: hexanes-dichloromethane=10:1, vol., then 5:1, vol.). This procedure gave 11.95 g (65%) of [2-methyl-4-(3,5-dimethylphenyl)-5-methoxy-6-tert-Butyl-1H-inden-1-yl][2-methyl-4-(3,5-dimethylphenyl)-1,5,6,7-tetrahydro-s-indacen-1-yl]dimethylsilane (as ca. 1:1 mixture of stereoisomers) as a yellowish glassy solid.

Anal. calc. for C₄₆H₅₄OSi: C, 84.87; H, 8.36. Found: C, 85.12; H, 8.59.

¹H NMR (CDCl₃): δ 7.48 and 7.33 (2s, sum 1H), 7.26-7.18 (m, 1H), 7.16-7.07 (m, 2H), 7.04-6.95 (m, 4H), 6.51 and 6.45 (2s, sum 2H), 3.69 and 3.65 (2s, sum 2H), 3.28 and 3.26 (2s, sum 3H), 3.01-2.74 (m, 4H), 2.38 ad 2.37 (2s, sum 12H), 2.20 and 2.15 (2s, sum 6H), 2.09-1.97 (m, 2H), 1.43 and 1.42 (2s, sum 9H), −0.17, −0.18, −0.19 and −0.24 (4s, sum 6H). ¹³C{¹H} NMR (CDCl₃): δ 155.29, 147.45, 147.39, 145.99, 145.75, 143.93, 143.90, 143.72, 143.69, 142.06, 142.01, 140.08, 140.06, 139.46, 139.37, 139.26, 139.03, 139.00, 138.24, 137.50, 137.34, 137.07, 136.99, 130.39, 128.23, 128.14, 127.92, 127.50, 127.46, 127.26, 126.12, 126.05, 125.99, 125.94, 120.55, 120.51, 118.46, 118.27, 60.49, 47.33, 46.86, 46.76, 35.14, 33.33, 33.28, 32.18, 31.26, 31.21, 25.95, 25.91, 21.44, 17.96, 17.88, −5.27, −5.39, −5.50, −5.82.

### Anti-dimethylsilanediyl[2-methyl-4-(3,5-dimethylphenyl)-5-methoxy-6-tert-butylinden-1-yl][2-methyl-4-(3,5-dimethylphenyl)-1,5,6,7-tetrahydro-s-indacen-1-yl]zirconium Dichloride

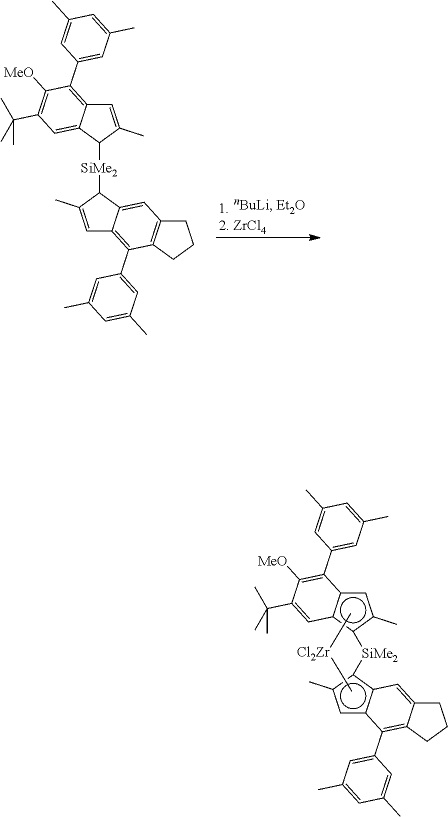

To a solution of 11.95 g (18.36 mol) of [2-methyl-4-(3,5-dimethylphenyl)-5-methoxy-6-tert-butyl-1H-inden-1-yl][2-methyl-4-(3,5-dimethylphenyl)-1,5,6,7-tetrahydro-s-indacen-1-yl]dimethylsilane (prepared above) in 200 ml of ether, cooled to −50° C., 15.1 ml (35.7 mmol) of 2.43 M ⁿBuLi in hexanes was added in one portion. This mixture was stirred for 3 h at room temperature, then the resulting red solution was cooled to −78° C., and 4.28 g (18.37 mmol) of ZrCl₄ was added. The reaction mixture was stirred for 24 h at room temperature to give light red solution with orange precipitate. This mixture was evaporated to dryness. The residue was treated with 250 ml of hot toluene, and the formed suspension was filtered through glass frit (G4). The filtrate was evaporated to 40 ml. Red powder precipitated from this solution overnight at room temperature was collected, washed with 10 ml of cold toluene, and dried in vacuum. This procedure gave 0.6 g of syn-zirconocene. The mother liquor was evaporated to ca. 35 ml, and 15 ml of n-hexane was added to the warm solution. The red powder precipitated from this solution overnight at room temperature was collected and dried in vacuum. This procedure gave 3.49 g syn-zirconocene. The mother liquor was evaporated to ca. 20 ml, and 30 ml of n-hexane was added to the warm solution. The yellow powder precipitated from this solution overnight at room temperature was collected and dried in vacuum. This procedure gave 4.76 g anti-zirconocene as a solvate with toluene (×0.6 toluene) contaminated with ca. 2% of syn-isomer. Thus, the total yield of syn- and anti-zirconocenes isolated in this synthesis was 8.85 g (59%).

### Anti-dimethylsilanediyl[2-methyl-4-(3,5-dimethylphenyl)-5-methoxy-6-tert-butylinden-1-yl][2-methyl-4-(3,5-dimethylphenyl)-1,5,6,7-tetrahydro-s-indacen-1-yl]zirconium Dichloride

Anal. calc. for C₄₆H₅₂Cl₂OSiZr×0.6C₇H₈: C, 69.59; H, 6.61. Found: C, 69.74; H, 6.68.

¹H NMR (CDCl₃): δ 7.47 (s, 1H), 7.40 (s, 1H), 7.37-7.03 (m, 4H), 6.95 (s, 2H), 6.71 (s, 1H), 6.55 (s, 1H), 3.43 (s, 3H), 3.03-2.96 (m, 2H), 2.96-2.87 (m, 1H), 2.87-2.76 (m, 1H), 2.34 and 2.33 (2s, sum 12H), 2.19 and 2.18 (2s, sum 6H), 2.06-1.94 (m, 2H), 1.38 (s, 9H), 1.28 (s, 3H), 1.27 (s, 3H). ¹³C{¹H} NMR (CDCl₃,): δ 159.73, 144.59, 143.99, 143.00, 138.26, 137.84, 137.59, 136.80, 135.35, 133.85, 133.63, 132.95, 132.52, 128.90, 128.80, 127.40, 126.95, 126.87, 126.65, 122.89, 121.61, 121.53, 120.82, 117.98, 81.77, 81.31, 62.62, 35.73, 33.20, 32.12, 30.37, 26.49, 21.47, 21.38, 18.40, 18.26, 2.64, 2.54.

### Syn-dimethylsilanediyl[2-methyl-4-(3,5-dimethylphenyl)-5-methoxy-6-tert-butylinden-1-yl][2-methyl-4-(3,5-dimethylphenyl)-1,5,6,7-tetrahydro-s-indacen-1-yl]zirconium Dichloride

Anal. calc. for C₄₆H₅₂C₁₂₀SiZr: C, 68.11; H, 6.46. Found: C, 68.37; H, 6.65.

¹H NMR (CDCl₃): δ 7.51 (s, 1H), 7.39 (s, 1H), 7.36-6.99 (m, 4H), 6.95 (s, 2H), 6.60 (s, 1H), 6.44 (s, 1H), 3.27 (s, 3H), 2.91-2.75 (m, 4H), 2.38 and 2.34 (2s, sum 18H), 1.99-1.87 (m, 1H), 1.87-1.74 (m, 1H), 1.42 (s, 3H), 1.36 (s, 9H), 1.19 (s, 3H). ¹³C{¹H} NMR (CDCl₃,): 158.74, 143.41, 142.84, 142.31, 138.30, 137.77, 137.55, 136.85, 135.87, 135.73, 134.99, 134.75, 131.64, 128.83, 128.76, 127.97, 127.32, 126.82, 126.22, 123.91, 121.35, 121.02, 120.85, 118.56, 83.47, 83.08, 62.32, 35.53, 33.33, 31.96, 30.33, 26.53, 21.45 (two resonances), 18.56, 18.43, 2.93, 2.65.

### Catalyst Preparation Examples

MAO was purchased from Chemtura and used as a 30 wt-% solution in toluene. As surfactants were used perfluoroalkylethyl acrylate esters (CAS number 65605-70-1) purchased from the Cytonix corporation, dried over activated molecular sieves (2 times) and degassed by argon bubbling prior to use (S1) or 1H,1H-Perfluoro(2-methyl-3-oxahexan-1-ol) (CAS 26537-88-2) purchased from Unimatec, dried over activated molecular sieves (2 times) and degassed by argon bubbling prior to use (S2).

Hexadecafluoro-1,3-dimethylyclohexane (PFC) (CAS number 335-27-3) was obtained from commercial sources and dried over activated molecular sieves (2 times) and degassed by argon bubbling prior to use.

Propylene is provided by Borealis and adequately purified before use.

Triethylaluminum was purchased from Crompton and used in pure form.

Hydrogen is provided by AGA and purified before use.

All the chemicals and chemical reactions were handled under an inert gas atmosphere using Schlenk and glovebox techniques, with oven-dried glassware, syringes, needles or cannulas.

### Comparative Catalyst CE1

Comparative Catalyst CE1 was prepared using metallocene MC-1 and MAO as cocatalyst according to Comp Cat 1 and Comp Cat 2 of WO 2015/011135.

### Inventive Catalyst IE1

Inventive Catalyst IE1 was prepared using metallocene MC-1 and a catalyst system of MAO and trityl tetrakis(pentafluorophenyl)borate according to Catalyst 3 of WO 2015/11135.

Comparative Catalyst CE2 (Al/S2=167 mol/mol)

Inside the glovebox, 86.4 mg of dry and degassed S2 were mixed with 2 mL of 30 wt.-% Chemtura MAO in a septum bottle and left to react overnight. The following day, 69.3 mg of metallocene MC-2 (0,076 mmol, 1 equivalent) were dissolved with 4 mL of the 30 wt.-% Chemtura MAO solution in another septum bottle and left under stirring inside the glovebox.

After 60 minutes, 1 mL of the MAO/surfactant solution and the 4 mL of the MAO-metallocene solution were successively added into a 50 mL emulsification glass reactor containing 40 mL of PFC at −10° C. and equipped with an overhead stirrer (stirring speed=600 rpm). A red emulsion formed immediately and stirred during 15 minutes at −10° C./600 rpm. Then the emulsion was transferred via a 2/4 teflon tube to 100 mL of hot PFC at 90° C., and stirred at 600 rpm until the transfer is completed, and then the speed was reduced to 300 rpm. After 15 minutes stirring, the oil bath was removed and the stirrer turned off. The catalyst was left to settle up on top of the PFC and after 35 minutes the solvent was siphoned off. The remaining catalyst was dried during 2 hours at 50° C. over an argon flow. 0.75 g of a red free flowing powder was obtained.

Inventive Catalyst 1E2 (Al/S2=250 mol/mol, B/Zr=1 mol/mol)

Inside the glovebox, S2 surfactant solution (28.8 mg of dry and degassed F16 dilute in 0.2 mL toluene) was added dropwise to 5 mL of 30 wt.-% Chemtura MAO. The solutions were left under stirring for 10 minutes. Then, 104.0 mg of metallocene MC-2 was added to MAO/surfactant. After 60 minutes, 105.0 mg of trityl tetrakis(pentafluorophenyl)borate was added. The mixture was left to react at room temperature inside the glovebox for 60 min.

Then, the surfactant-MAO-metallocene-borate solution were added into a 50 mL emulsification glass reactor containing 40 mL of PFC at −10° C. and equipped with an overhead stirrer (stirring speed=600 rpm). A yellow emulsion formed immediately and stirred during 15 minutes at −10° C./600 rpm. Then the emulsion was transferred via a 2/4 Teflon tube to 100 mL of hot PFC at 90° C. and stirred at 600 rpm until the transfer is completed. Then the speed was reduced to 300 rpm. After 15 minutes stirring, the oil bath was removed and the stirrer turned off. The catalyst was left to settle up on top of the PFC and after 35 minutes the solvent was siphoned off The remaining catalyst was dried during 2 hours at 50° C. over an argon flow. 0.6 g of a yellow free flowing powder was obtained.

Comparative Catalyst CE3 (Al/S2=167 mol/mol)

Inside the glovebox, 86.2 mg of dry and degassed S2 were mixed with 2 mL of 30 wt.-% Chemtura MAO in a septum bottle and left to react overnight. The following day, 65.1 mg of metallocene MC-3 (0,076 mmol, 1 equivalent) were dissolved with 4 mL of the 30 wt.-% Chemtura MAO solution in another septum bottle and left under stirring inside the glovebox.

After 60 minutes, 1 mL of the MAO/surfactant solution and the 4 mL of the MAO-metallocene solution were successively added into a 50 mL emulsification glass reactor containing 40 mL of PFC at −10° C. and equipped with an overhead stirrer (stirring speed=600 rpm). A red emulsion formed immediately and stirred during 15 minutes at −10° C./600 rpm. Then the emulsion was transferred via a 2/4 teflon tube to 100 mL of hot PFC at 90° C., and stirred at 600 rpm until the transfer is completed, and then the speed was reduced to 300 rpm. After 15 minutes stirring, the oil bath was removed and the stirrer turned off. The catalyst was left to settle up on top of the PFC and after 35 minutes the solvent was siphoned off. The remaining catalyst was dried during 2 hours at 50° C. over an argon flow. 0.79 g of a red free flowing powder was obtained.

Inventive Catalyst 1E3 (Al/S2=250 mol/mol, B/Zr=1 mol/mol)

Inside the glovebox, S2 surfactant solution (28.8 mg of dry and degassed F16 dilute in 0.2 mL toluene) was added dropwise to 5 mL of 30 wt.-% Chemtura MAO. The solutions were left under stirring for 10 minutes. Then, 97.7 mg of metallocene MC-3 was added to MAO/surfactant. After 60 minutes, 105.0 mg of trityl tetrakis(pentafluorophenyl)borate was added. The mixture was left to react at room temperature inside the glovebox for 60 min.

Then, the surfactant-MAO-metallocene-borate solution were added into a 50 mL emulsification glass reactor containing 40 mL of PFC at −10° C. and equipped with an overhead stirrer (stirring speed=600 rpm). A yellow emulsion formed immediately and stirred during 15 minutes at −10° C./600 rpm. Then the emulsion was transferred via a 2/4 Teflon tube to 100 mL of hot PFC at 90° C. and stirred at 600 rpm until the transfer is completed. Then the speed was reduced to 300 rpm. After 15 minutes stirring, the oil bath was removed and the stirrer turned off. The catalyst was left to settle up on top of the PFC and after 35 minutes the solvent was siphoned off The remaining catalyst was dried during 2 hours at 50° C. over an argon flow. 0.70 g of a yellow free flowing powder was obtained.

### Comparative Catalyst CE4:

Inside the glovebox, 85.9 mg of dry and degassed surfactant S2 were mixed with 2 mL of MAO in a septum bottle and left to react overnight. The following day, 43.9 mg of MC-4 (0,051 mmol, 1 equivalent) were dissolved with 4 mL of the MAO solution in another septum bottle and left to stir inside the glovebox.

After 60 minutes, 1 mL of the surfactant solution and the 4 mL of the MAO-metallocene solution were successively added into a 50 mL emulsification glass reactor containing 40 mL of PFC at −10° C. and equipped with an overhead stirrer (stirring speed=600 rpm). A red emulsion formed immediately and stirred during 15 minutes at −10° C./600 rpm. Then the emulsion was transferred via a 2/4 teflon tube to 100 mL of hot PFC at 90° C., and stirred at 600 rpm until the transfer is completed, then the speed was reduced to 300 rpm. After 15 minutes stirring, the oil bath was removed and the stirrer turned off. The catalyst was left to settle up on top of the PFC and after 35 minutes the solvent was siphoned off. The remaining red catalyst was dried during 2 hours at 50° C. over an argon flow. 0.62 g of a red free flowing powder was obtained.

### Inventive Catalyst 1E4:

Inside the glovebox, 28.8 mg of dry and degassed surfactant S2 (in 0.2 mL toluene) were added dropwise to 5 mL of MAO. The solution was left under stirring for 10 minutes. Then, 98.7 mg of MC-4 were added to the MAO/surfactante solution. After 60 minutes stirring, 104.9 mg of trityl tetrakis(pentafluorophenyl)borate were added. After 60 minutes stirring, the surfactant-MAO-metallocene-borate solution was successively added into a 50 mL emulsification glass reactor containing 40 mL of PFC at −10° C. and equipped with an overhead stirrer (stirring speed=600 rpm). A red emulsion formed immediately and was stirred during 15 minutes at −10° C./600 rpm. Then the emulsion was transferred via a 2/4 teflon tube to 100 mL of hot PFC at 90° C., and stirred at 600 rpm until the transfer is completed, then the speed was reduced to 300 rpm. After 15 minutes stirring, the oil bath was removed and the stirrer turned off. The catalyst was left to settle up on top of the PFC and after 35 minutes the solvent was siphoned off. The catalyst was left to settle up on top of the PFC and after 35 minutes the solvent was siphoned off. The remaining catalyst was dried during 2 hours at 50° C. under argon flow. 0.90 g of a red free flowing powder was obtained.

### Comparative Catalyst CE5:

Inside the glovebox, 85.3 mg of dry and degassed surfactant S2 were mixed with 2 mL of MAO in a septum bottle and left to react overnight. The following day, 42.4 mg of MC-5 (0,051 mmol, 1 equivalent) were dissolved with 4 mL of the MAO solution in another septum bottle and left to stir inside the glovebox.

After 60 minutes, 1 mL of the surfactant solution and the 4 mL of the MAO-metallocene solution were successively added into a 50 mL emulsification glass reactor containing 40 mL of PFC at −10° C. and equipped with an overhead stirrer (stirring speed=600 rpm). A red emulsion formed immediately and stirred during 15 minutes at −10° C./600 rpm. Then the emulsion was transferred via a 2/4 teflon tube to 100 mL of hot PFC at 90° C., and stirred at 600 rpm until the transfer is completed, then the speed was reduced to 300 rpm. After 15 minutes stirring, the oil bath was removed and the stirrer turned off. The catalyst was left to settle up on top of the PFC and after 35 minutes the solvent was siphoned off. The remaining red catalyst was dried during 2 hours at 50° C. over an argon flow. 0.52 g of a red free flowing powder was obtained.

### Inventive Catalyst 1E5:

Inside the glovebox, 28.8 mg of dry and degassed surfactant S2 (in 0.2 mL toluene) were added dropwise to 5 mL of MAO. The solution was left under stirring for 10 minutes. Then, 92.3 mg of MC-5 were added to the MAO/surfactante solution. After 60 minutes stirring, 106.0 mg of trityl tetrakis(pentafluorophenyl)borate were added.

After 60 minutes stirring, the surfactant-MAO-metallocene-borate solution was successively added into a 50 mL emulsification glass reactor containing 40 mL of PFC at −10° C. and equipped with an overhead stirrer (stirring speed=600 rpm). A red emulsion formed immediately and was stirred during 15 minutes at −10° C./600 rpm. Then the emulsion was transferred via a 2/4 teflon tube to 100 mL of hot PFC at 90° C., and stirred at 600 rpm until the transfer is completed, then the speed was reduced to 300 rpm. After 15 minutes stirring, the oil bath was removed and the stirrer turned off. The catalyst was left to settle up on top of the PFC and after 35 minutes the solvent was siphoned off. The catalyst was left to settle up on top of the PFC and after 35 minutes the solvent was siphoned off. The remaining catalyst was dried during 2 hours at 50° C. under argon flow. 0.60 g of a red free flowing powder was obtained.

### Comparative Catalyst CE6:

Inside the glovebox, 86.8 mg of dry and degassed surfactant S2 were mixed with 2 mL of MAO in a septum bottle and left to react overnight. The following day, 41.1 mg of MC-6 (0,051 mmol, 1 equivalent) were dissolved with 4 mL of the MAO solution in another septum bottle and left to stir inside the glovebox.

After 60 minutes, 1 mL of the surfactant solution and the 4 mL of the MAO-metallocene solution were successively added into a 50 mL emulsification glass reactor containing 40 mL of PFC at −10° C. and equipped with an overhead stirrer (stirring speed=600 rpm). A red emulsion formed immediately and stirred during 15 minutes at −10° C./600 rpm. Then the emulsion was transferred via a 2/4 teflon tube to 100 mL of hot PFC at 90° C., and stirred at 600 rpm until the transfer is completed, then the speed was reduced to 300 rpm. After 15 minutes stirring, the oil bath was removed and the stirrer turned off. The catalyst was left to settle up on top of the PFC and after 35 minutes the solvent was siphoned off. The remaining red catalyst was dried during 2 hours at 50° C. over an argon flow. 0.54 g of a red free flowing powder was obtained.

### Inventive Catalyst 1E6:

Inside the glovebox, 234.3 mg of dry and degassed surfactant S2 (in 0.2 mL toluene) were added dropwise to 5 mL of MAO. The solution was left under stirring for 30 minutes. Then, 95.6 mg of MC-6 were added to the MAO/surfactante solution. After 60 minutes stirring, 104.9 mg of trityl tetrakis(pentafluorophenyl)borate were added. After 60 minutes stirring, 5 mL of the surfactant-MAO-metallocene-borate solution was successively added into a 50 mL emulsification glass reactor containing 40 mL of PFC at −10° C. and equipped with an overhead stirrer (stirring speed=600 rpm). A red emulsion formed immediately and was stirred during 15 minutes at −10° C./600 rpm. Then the emulsion was transferred via a 2/4 teflon tube to 100 mL of hot PFC at 90° C., and stirred at 600 rpm until the transfer is completed, then the speed was reduced to 300 rpm. After 15 minutes stirring, the oil bath was removed and the stirrer turned off. The catalyst was left to settle up on top of the PFC and after 35 minutes the solvent was siphoned off. The catalyst was left to settle up on top of the PFC and after 35 minutes the solvent was siphoned off. The remaining catalyst was dried during 2 hours at 50° C. under argon flow. 0.70 g of a red free flowing powder was obtained.

In Table 1 the Al (wt. %), Zr (wt. %) and Al/Zr ratio for the catalysts of metallocenes MC-2, MC-3, MC-4, MC-5 and MC-6 are shown.

TABLE 1
based on ICP

| | Al | Zr | Al/Zr |
|---|---|---|---|
| Example | [wt %] | [wt %] | [mol/mol] |
| CE2 | 36.3 | 0.43 | 285 |
| CE3 | 36.2 | 0.41 | 298 |
| CE4 | 36.2 | 0.27 | 453 |
| CE5 | 37.0 | 0.26 | 481 |
| CE6 | 36.9 | 0.26 | 480 |
| IE2 | 30.6 | 0.56 | 185 |
| IE3 | 30.9 | 0.52 | 201 |
| IE4 | 30.2 | 0.55 | 186 |
| IE5 | 31.8 | 0.50 | 215 |
| IE6 | 31.9 | 0.56 | 193 |

### Off-Line Prepolymerization Procedure

Off-line prepolymerized catalysts with metallocenes MC-1, MC-2, MC-3, MC-4, MC-5 and MC-6 were prepolymerized according to the following procedure: The pre-polymerization experiment was done in a 125 mL pressure reactor equipped with gas-feeding lines and an overhead stirrer. Dry and degassed perfluoro-1.3-dimethylcyclohexane (15 cm³) and the desired amount of the catalyst to be pre-polymerized were loaded into the reactor inside a glove box and the reactor was sealed. The reactor was then taken out from the glove box and placed inside a water cooled bath kept at 25° C. The overhead stirrer and the feeding lines were connected and stirring speed set to 450 rpm. The experiment was started by opening the propylene feed into the reactor. The total pressure in the reactor was raised to about 5 barg and held constant by propylene feed via mass flow controller until the target degree of polymerization was reached. The reaction was stopped by flashing the volatile components. Inside glove box, the reactor was opened and the content poured into a glass vessel. The perfluoro-1,3-dimethylcyclohexane was evaporated until a constant weight was obtained to yield the pre-polymerized catalyst.

TABLE 2
Off-line prepolymerization.

| | | DP | MC in prepolymerized | Yield |
|---|---|---|---|---|
| Example | Metallocene | [wt/wt] | Cat [wt %] | (g)* |
| CE1 | MC-1 | | | |
| CE2 | MC-2 | 3.53 | 1.2 | 1.8258 |
| CE3 | MC-3 | 3.20 | 1.1 | 1.7145 |
| CE4 | MC-4 | 3.54 | 0.70 | 1.8154 |
| CE5 | MC-5 | 3.43 | 0.66 | 1.8096 |
| CE6 | MC-6 | 3.15 | 0.68 | 1.6670 |
| IE1 | MC-1 | | | |
| IE2 | MC-2 | 5.60 | 1.2 | 3.2734 |
| IE3 | MC-3 | 5.57 | 1.0 | 2.7331 |
| IE4 | MC-4 | 3.56 | 1.63 | 2.3115 |
| IE5 | MC-5 | 3.30 | 1.47 | 1.8737 |
| IE6 | MC-6 | 5.47 | 1.05 | 2.6214 |

DP degree of prepolymerization
*prepolymerized catalyst amount

### Polymerization Examples

All bench scale experiments were performed in a stirred autoclave equipped with a ribbon stirrer and a total volume of 21 dm³.

The autoclave containing 0.2 bar-g propylene is filled with additional 3.95 kg propylene and a chosen amount of 1-butene or 1-hexene. The amount is calculated so that the total amount of propylene in the reactor after all feeds summed up to 4.45 kg. After addition of 0.4 ml triethylaluminium (0.62 molar solution in n-heptane) using a stream of 250 g propylene the solution is stirred at 20° C. and 250 rpm for at least 20 min. Afterwards the reactor is brought up to the set pre-polymerization temperature of 20° C. and the catalyst is injected as described in the following.

The solid, pre-polymerized catalyst is loaded into a 5-mL stainless steel vial inside the glove box. The vial is attached to the autoclave, then a second 5-mL vial containing 4 ml n-heptane and pressurized with 10 bars of N₂ is added on top. The chosen amount of hydrogen is dosed into the reactor via flow controller. The valve between the two vials is opened and the solid catalyst is contacted with heptane under N₂ pressure for 2 s, and then flushed into the reactor with 250 g propylene. Stirring speed is held at 250 rpm and pre-polymerization is run for the set time. Now the polymerization temperature is increased to 75° C. The reactor temperature is held constant throughout the polymerization. The polymerization time is measured starting when the temperature reaches 73° C. If needed propylene, butene and hexene were fed continuously throughout the reaction in order to keep the pressure constant. When the polymerization time has lapsed, the reaction is stopped by injecting 5 ml ethanol, cooling the reactor and flushing the volatile components. After purging the reactor three times with nitrogen and one vacuum/nitrogen cycle, the product is taken out and dried overnight in a hood.

### Results:

a) Polymerization of propylene/1-hexene copolymers in the presence of catalysts IE1 and CE1

| | Inventive | Inventive | Inventive | comparative | comparative |
|---|---|---|---|---|---|
| | example 1 | example 2 | example 3 | example 1 | example 2 |
| Catalyst | IE1 | IE1 | IE1 | CE1 | CE1 |
| Propylene total [g] | 4450 | 4456 | 4427 + 977 | 4451 | 4461 |
| Hexene total [g] | 119 | 168 | 152 + 21 | 102 | 144 |
| Hydrogen [mol] | 0.111 | 0.158 | 0.064 | 0.054 | 0.068 |
| Average C6/C3 in | 19 | 26 | 21 | 15 | 20 |
| liquid phase | | | | | |
| [mol/kmol] | | | | | |
| Average H2/C3 in | 0.33 | 0.46 | 0.20 | 0.17 | 0.21 |
| liquid phase | | | | | |
| [mol/kmol] | | | | | |
| MFR [g/10 min] | 3 | 9.6 | 3.7 | 3 | 9.6 |
| C6 in polymer, | 2.02 | 3.03 | 2.4 | 1.84 | 2.83 |
| FTIR [wt %] | | | | | |
| C6 in polymer, | 2.1 | 3.1 | 2.6 | 2.0 | 3.0 |
| NMR [wt %] | | | | | |
| Prepped catalyst | 14 | 12.7 | 9.6 | 5.5 | 5 |
| activity [kg/(g · h)] | | | | | |
| Unprepped catalyst | 113 | 103 | 78 | 25 | 22 |
| activity [kg/(g · h)] | | | | | |
| Metallocene | 2186 | 1990 | 1506 | 1173 | 1054 |
| activity [kg/(g · h)] | | | | | |
| XS (wt %] | 0.1 | 0.1 | 0.1 | 0.3 | 0.3 |
| Powder bulk | 440 | 420 | 440 | 520 | 520 |
| density [kg/m³] | | | | | |
| Mw [g/mol] | 272000 | 197500 | 259500 | 288000 | 208000 |

b) Polymerization of propylene/1-butene copolymers in the presence of catalysts IE1 and CE1

| | Inventive | Inventive | comparative | comparative |
|---|---|---|---|---|
| | example 4 | example 5 | example 3 | example 4 |
| Catalyst | IE1 | IE1 | CE1 | CE1 |
| Propylene total [g] | 4420 + 653 | 4426 + 742 | 4424 + 1301 | 4427 + 1107 |
| Butene total [g] | 150 + 22 | 284 + 46 | 150 + 52 | 284 + 68 |
| Hydrogen [mol] | 0.067 | 0.064 | 0.067 | 0.064 |
| Average C4/C3 in liquid | 29 | 54 | 29 | 53 |
| phase [mol/kmol] | | | | |
| Average H2/C3 in liquid | 0.21 | 0.21 | 0.22 | 0.21 |
| phase [mol/kmol] | | | | |
| MFR [g/10 min] | 7.5 | 8.8 | 17 | 30 |
| C4 in polymer, NMR [wt %] | 2.8 | 4.9 | 3.0 | 5.7 |
| Prepped catalyst activity | 7.1 | 7.4 | 8.1 | 8.3 |
| [kg/(g · h)] | | | | |
| Unprepped catalyst activity | 54 | 56 | 32 | 33 |
| [kg/(g · h)] | | | | |
| Metallocene activity | 1115 | 1161 | 1724 | 1769 |
| [kg/(g · h)] | | | | |
| XS (wt %] | 0.2 | 0.2 | 0.3 | 0.2 |
| Powder bulk density | 430 | 480 | 500 | 520 |
| [kg/m³] | | | | |
| Mw [g/mol] | 231000 | 217500 | 184500 | 148500 |

c) Polymerization of propylene/1-hexene copolymers in the presence of catalysts IE2, IE3, IE4, IE5, IE6, CE2, CE3, CE4, CE5 and CE6

| | | Prep | Unprep | MC content of | MC content in |
|---|---|---|---|---|---|
| | B/Zr | degree | catalyst | unprep cat (ICP) | dosed prep cat |
| Catalyst | mol/mol | wt/wt | mg | wt % | mg |
| IE2 | 1 | 5.5 | 11.69 | 1.25 | 0.95 |
| IE3 | 1 | 5.57 | 12.48 | 1.04 | 0.85 |
| IE4 | 1 | 3.56 | 11.84 | 1.63 | 0.88 |
| IE5 | 1 | 3.30 | 12.79 | 1.47 | 0.81 |
| IE6 | 1 | 5.47 | 13.45 | 1.05 | 0.91 |
| CE2 | 0 | 3.53 | 22.96 | 1.15 | 1.20 |
| CE3 | 0 | 3.20 | 25.00 | 1.11 | 1.17 |
| CE4 | 0 | 3.54 | 24.23 | 0.70 | 0.77 |
| CE5 | 0 | 3.43 | 23.70 | 0.66 | 0.69 |
| CE6 | 0 | 3.15 | 25.30 | 0.68 | 0.71 |

TABLE 6
Properties of propylene/1-hexene copolymers (IE2,
IE3, IE4, IE5, IE6, CE2, CE3, CE4, CE5, CE6)

| | Catalyst | | | | | |
|---|---|---|---|---|---|---|
| | produc- | MC | | C6 | | |
| | tivity | activity | MFR₂ | (NMR) | Mw | |
| Catalyst | kg/g | kg/g · h | g/10 min | wt % | kg/mol | Mw/Mn |
| IE2 | 101.6 | 1251 | 5.8 | 2.5 | 232 | 2.3 |
| IE3 | 95.0 | 1391 | 5.3 | 3.3 | 232 | 2.4 |
| IE4 | 117.7 | 1584 | 3.2 | 2.4 | 284 | 2.4 |
| IE5 | 116.3 | 1840 | 2.5 | 3.0 | 298 | 2.6 |
| IE6 | 136.5 | 2009 | 2.1 | 3.0 | 325 | 2.5 |
| CE2 | 45.3 | 870 | 20.2 | 3.0 | 169 | 2.2 |
| CE3 | 53 | 1132 | 9.1 | 3.7 | 310 | 2.2 |
| CE4 | 27 | 849 | 17.1 | 2.8 | 178 | 2.2 |
| CE5 | 36 | 1240 | 20.0 | 3.1 | 165 | 2.2 |
| CE6 | 29.4 | 1043 | 16.5 | 3.6 | 181 | 2.3 |

1. A process for polymerizing a copolymer of propylene and at least one comonomer selected from alpha olefins having from 4 to 12 carbon atoms, and optionally ethylene, in the presence of a single-site catalyst comprising
(i) a complex of formula (I) 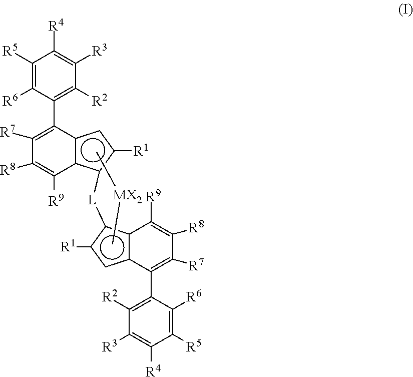
wherein
M is zirconium or hafnium;
each X independently is a sigma-donor ligand
L is a bridge of formula -(ER¹⁰₂)_{y}—;
y is 1 or 2;
E is C or Si;
each R¹⁰ is independently a C₁-C₂₀-hydrocarbyl group, tri(C₁-C₂₀ alkyl)silyl group, C₆-C₂₀ aryl group, C₇-C₂₀ arylalkyl group or C₇-C₂₀ alkylaryl group or L is an alkylene group such as methylene or ethylene;
R¹ are each independently the same or are different from each other and are a CH₂—R¹¹ group, with R¹¹ being H or linear or branched C₁-C₆ alkyl group, C₃-C₈ cycloalkyl group, C₆-C₁₀ aryl group;
R³, R⁴ and R⁵ are each independently the same or different from each other and are H or a linear or branched C₁-C₆ alkyl group, C₇-C₂₀ arylalkyl group, C₇-C₂₀ alkylaryl group, or C₆-C₂₀ aryl group with the proviso that if there are four or more R³, R⁴ and R⁵ groups different from H present in total, one or more of R³, R⁴ and R⁵ is other than tert butyl;
R⁷ and R⁸ are each independently the same or different from each other and are H, a CH₂—R¹² group, with R¹² being H or linear or branched C₁-C₆ alkyl group, SiR¹³₃, GeR¹³₃, OR¹³, SR¹³, NR¹³₂,
wherein
R¹³ is a linear or branched C₁-C₆ alkyl group, C₇-C₂₀ alkylaryl group and C₇-C₂₀ arylalkyl group or C₆-C₂₀ aryl group,
and/or
R⁷ and R⁸ are part of a C₄-C₂₀ carbon ring system together with the indenyl carbons to which they are attached, optionally one carbon atom can be substituted by a nitrogen, sulfur or oxygen atom;
R⁹ are each independently the same or different from each other and are H or a linear or branched C₁-C₆ alkyl group; and
R² and R⁶ all are H; and
(ii) a cocatalyst system comprising a boron containing cocatalyst and an aluminoxane cocatalyst;
and in the presence of hydrogen.

2. The process according to claim 1, wherein the aluminoxane cocatalyst is one of formula (X) 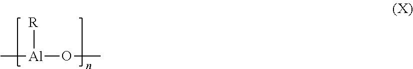
where n is from 6 to 20 and R can be C₁-C₁₀ alkyl, or C₃-C₁₀-cycloalkyl, C₇-C₁₂-arylalkyl or alkylaryl and/or phenyl or naphthyl.

3. The process according to claim 1, wherein the boron based cocatalyst is one of formula (Z)
BY₃ (Z)
wherein Y independently is the same or can be different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine.

4. The process according to claim 1, wherein the boron based cocatalyst is one of compounds containing a borate anion.

5. The process according to claim 1, wherein the molar ratio of boron in the boron containing cocatalyst to the metal ion M in the complex of formula (I) is in the range of 0.5:1 to 10:1 mol/mol.

6. The process according to claim 1, wherein the molar ratio of aluminium in the aluminoxane cocatalyst to the metal ion M in the complex of formula (I) is in the range of 1:1 to 2000:1 mol/mol.

7. The process according to claim 1 comprising the steps of
a) introducing propylene monomer units, alpha-olefin comonomer units having from 4 to 12 carbon atoms, optionally ethylene comonomer units and hydrogen into a polymerization reactor;
b) polymerizing the propylene monomer units, the optional ethylene comonomer, and alpha-olefin comonomer units having from 4 to 12 carbon atoms to form a copolymer of propylene and at least one comonomer selected alpha-olefins from having from 4 to 12 carbon atoms in the presence the single-site catalyst.

8. The process according to claim 7, wherein the molar ratio of hydrogen to propylene, [H₂/C₃], in process step b) is at least 0.18 mol/kmol.

9. The process according to claim 1, wherein the single-site catalyst has an unpolymerized catalyst activity of at least 35 kg/(g·h).

10. The process according to claim 7, wherein the process further comprises the steps of
c) transferring the polymerization mixture comprising the copolymer of propylene and at least one comonomer selected from alpha olefins having from 4 to 12 carbon atoms from process step b) into a second polymerization reactor; and
d) polymerizing the propylene monomer units and alpha-olefin comonomer units having from 4 to 12 carbon atoms to form a copolymer of propylene and at least one comonomer selected alpha-olefins from having from 4 to 12 carbon atoms in the presence the single-site catalyst in the presence of the copolymer of propylene and at least one comonomer selected from alpha olefins having from 4 to 12 carbon atoms formed in process step b).

11. A copolymer of propylene and at least one comonomer selected from alpha olefins having from 4 to 12 carbon atoms or a terpolymer of propylene, ethylene and at least one comonomer selected from alpha olefins having from 4 to 12 carbon atoms obtainable from the process according to claim 1, wherein the copolymer of propylene and at least one comonomer selected from alpha olefins having from 4 to 12 carbon atoms follows the following relation (A) in behalf of its polymerization process:
MFR₂/[H₂/C₃]≤55 [g/10 min/mol/kmol] (A)
with
MFR₂ melt flow rate in g/10 min of the copolymer of propylene and at least one comonomer selected from alpha olefins having from 4 to 12 carbon atoms or terpolymer of propylene, ethylene and at least one comonomer selected from alpha olefins having from 4 to 12 carbon atoms, determined according to ISO 1133 at a temperature of 230° C. and a load of 2.16 kg;
[H₂/C₃] molar ratio of hydrogen to propylene in mol/kmol in process step b) wherein the molar ratio of hydrogen to propylene, [H₂/C₃], in process step b) is at least 0.18 mol/kmol.

12. The copolymer of propylene and at least one comonomer selected from alpha olefins having from 4 to 12 carbon atoms or terpolymer of propylene, ethylene and at least one comonomer selected from alpha olefins having from 4 to 12 carbon atoms according to claim 11, wherein the copolymer of propylene and at least one comonomer selected from alpha olefins having from 4 to 12 carbon atoms follows the following relation (B) in behalf of its polymerization process:
Mw·[H₂/C₃]≥44 kg/kmol (B)
Mw weight average molecular weight in kg/mol of the copolymer of propylene and at least one comonomer selected from alpha olefins having from 4 to 12 carbon atoms or terpolymer of propylene, ethylene and at least one comonomer selected from alpha olefins having from 4 to 12 carbon atoms; and
[H₂/C₃] molar ratio of hydrogen to propylene in mol/kmol in process step b).

13. The copolymer of propylene and at least one comonomer selected from alpha olefins having from 4 to 12 carbon atoms or terpolymer of propylene, ethylene and at least one comonomer selected from alpha olefins having from 4 to 12 carbon atoms according to claim 11 having a comonomer content of from 0.1 mol % to 5.0 mol %.

14. The copolymer of propylene and at least one comonomer selected from alpha olefins having from 4 to 12 carbon atoms or terpolymer of propylene, ethylene and at least one comonomer selected from alpha olefins having from 4 to 12 carbon atoms according to claim 11 being a copolymer of propylene and 1-hexene or a copolymer of propylene and 1-butene.

15. (canceled)
